(19) United States
(12) Patent Application Publication
(10) Pub. No.: US 2014/0167957 A1
(43) Pub. Date: Jun. 19, 2014

(54) LOCATOR SYSTEM, MOBILE INFORMATION TERMINAL, AND LOCATOR

(71) Applicant: Panasonic Corporation, Osaka (JP)

(72) Inventors: Hiroshi Tsuji, Fukuoka (JP); Yutaka Ikeda, Fukuoka (JP); Shinya Hokazono, Fukuoka (JP)

(73) Assignee: Panasonic Corporation, Osaka (JP)

(21) Appl. No.: 14/102,168

(22) Filed: Dec. 10, 2013

(30) Foreign Application Priority Data
Dec. 13, 2012 (JP) 2012-272409

(51) Int. Cl. G08B 5/22; H04B 5/04

(52) U.S. Cl. CPC G08B 5/224; H04B 5/04
USPC 340/539.13

(57) ABSTRACT

Disclosed are a locator system, a mobile information terminal, and a locator that realize a specific apparatus (locator) small in size and with a low price and that make it possible to easily find a lost device by building a link with a highly functional mobile information terminal. The mobile information terminal performs an operation of calling the locator regularly, performs location information calculation using a GPS, and stores self-location data in a storage section. The mobile information terminal records self-location data before and after being determined to be lost, so that a map can be displayed based on the self-location data, and the location of the locator can be efficiently found.

### CROSS REFERENCE TO RELATED APPLICATIONS

This application is entitled and claims the benefit of Japanese Patent Application No. 2012-272409, filed on Dec. 13, 2012, the disclosure of which including the specification, drawings and abstract is incorporated herein by reference in its entirety.

### TECHNICAL FIELD

The present invention relates to a locator system, a mobile information terminal, and a locator that prevent the loss of a mobile information terminal or the loss of a locator.

### BACKGROUND ART

Radio anti-theft apparatuses used for detecting items (also referred to as “target objects” such as a key, wallet, mobile device, and pet) are known. For example, Japanese Patent Application Laid-Open No. HEI 10-105627 discloses an anti-theft apparatus which transmits and receives a presence check signal through low-power transmission to and from an electronic currency dealing machine as a counterpart device and which warns the owner of the electronic currency dealing machine when no longer receiving a presence check signal from the electronic currency dealing machine.

In addition, Japanese Patent Application Laid-Open No. 2002-223478 discloses a mobile terminal apparatus including a unit that performs radio communication with a public radio network using electric waves, a GPS location information calculating unit that detects a location, and a reception circuit that receives signals from a specific apparatus. The mobile terminal apparatus has a function of intermittently receiving signals from the specific apparatus, giving a sound notification when detecting that the reception level of the received signal is lower than a predetermined value for a predetermined period and transmitting location detection information using a GPS via the public radio communication section at the time of the loss of the mobile terminal apparatus, or emergency.

### CITATION LIST

### Patent Literature

PTL1
Japanese Patent Application Laid-Open No. HEI 10-105627
PTL2
Japanese Patent Application Laid-Open No. 2002-223478

### SUMMARY OF INVENTION

### Technical Problem

According to the related art described above, increasing the frequency of intermittent communication between the mobile information terminal and the specific apparatus makes it possible to issue a notification right after the loss of mobile information terminal and thereby to allow a user to promptly know the loss of mobile information terminal. Meanwhile, it is desirable to reduce the size and costs of the specific apparatus, and the capacity of a built-in battery is limited. In addition, increasing the frequency of communication between the mobile information terminal and the specific apparatus wears out the battery faster, thus requiring frequent replacement of battery.

On the other hand, decreasing the frequency of communication between the mobile information terminal and the specific apparatus reduces the wear-out of the battery but, it will take longer time for the user to notice the loss of mobile information terminal. In addition, when the user moves without being aware of the notification issued at the time of the loss and recognize the loss after elapse of time, it will be difficult to identify the place where the loss has occurred. As a result, there arises a problem in that it is no longer possible to efficiently find the mobile information terminal.

An object of the present invention is to provide a locator system, a mobile information terminal and a locator that makes it possible to realize a specific apparatus (locator) small in size and with a low price and also to easily find a lost mobile information terminal by building a link with a highly functional mobile information terminal.

### Solution to Problem

In order to achieve the abovementioned object, a locator system according to an aspect of the present invention includes: a mobile information terminal that includes a public radio communication section performing radio communication with a public radio network and that includes a near field radio communication section performing communication with a specific apparatus using a near field radio communication protocol; and a radio communication section that communicates with the mobile information terminal using a near field radio communication protocol, in which: the mobile information terminal transmits a locator calling signal used for calling a locator regularly and waits for a response signal when the mobile information terminal is set in a locator monitoring mode, the response signal being transmitted from the locator; and the mobile information terminal generates a confirmation sound when a state in which the mobile information terminal does not receive the response signal in a normal way continues for a predetermined time, the response signal being transmitted from the locator in response to the locator calling signal.

A locator system according to an aspect of the present invention includes: a mobile information terminal that includes a public radio communication section performing radio communication with a public radio network and that includes a near field radio communication section performing communication with a specific apparatus using a near field radio communication protocol; and a locator that includes a radio communication section performing communication with the mobile information terminal using a near field radio communication protocol and that includes a user operable switch, in which: the radio communication section of the locator performs an operation of searching for the mobile information terminal in accordance with a user operation of pressing the switch; and upon reception of a switch pressing message from the locator, the mobile information terminal transmits a response message representing the reception of the message and generates a confirmation sound using voice.

### Advantageous Effects of Invention

According to the present invention, a link between a locator and a highly functional mobile information terminal is built. Accordingly, when one of the locator and the terminal cannot be found, the user can promptly recognize that one of the devices has been missing and can effectively look for the device. In addition, a notification can be appropriately given at the time of emergency.

### BRIEF DESCRIPTION OF DRAWINGS

FIG. 1 is a system configuration diagram that illustrates an example of a locator system according to the present invention;

FIG. 2 is a block diagram that illustrates an example of the use form of the locator system;

FIG. 3 is a block diagram that illustrates a configuration example of a locator of the locator system;

FIG. 4 is a block diagram that illustrates a configuration example of a mobile information terminal of the locator system;

FIG. 5 is a block diagram that illustrates a configuration example of a base unit of the locator system;

FIG. 6 is a timing diagram that illustrates an example of TDMA communication between a base unit and a cordless handset (or a mobile information terminal) in a normal state in the locator system;

FIG. 7 is a flowchart that illustrates an example of a normal operation of the mobile information terminal for searching for the locator in the locator system;

FIG. 8 is a timing diagram that illustrates a communication operation performed between the mobile information terminal and the locator in the locator system according to the present invention;

FIG. 9 is a schematic diagram that illustrates an example of a case where a user goes out having the locator and the mobile information terminal with him in the locator system according to the present invention;

FIG. 10 is a schematic diagram that illustrates an example of information that is recorded in a self-location data table of the mobile information terminal of the locator system according to the present invention;

FIG. 11 is a schematic diagram that illustrates an example of a case where a user of the locator system according to the present invention has the mobile information terminal with him, and the locator is far apart from the user;

FIG. 12 is a schematic diagram that illustrates an example of displaying a map on the mobile information terminal after the mobile information terminal and the locator are far apart from each other in the locator system according to the present invention;

FIG. 13 is a schematic diagram that illustrates an example of a case where the mobile information terminal is far apart from the user while having the locator with him in the locator system according to the present invention;

FIG. 14 is a flowchart that illustrates an example of the operation performed in the locator system according to the present invention in an information terminal monitoring mode;

FIG. 15 is a schematic diagram that illustrates an example of a case where a user goes out having the mobile information terminal with him without possessing the locator in the locator system according to the present invention;

FIG. 16 is a schematic diagram that illustrates an example of a case where the user stays in his house while having the locator with him in the locator system according to the present invention, and the mobile information terminal is present also in the house;

FIG. 17 is a schematic diagram that illustrates an example of a case where the user uses the locator as an emergency button in the state in which the user goes out, in the locator system according to the present invention;

FIG. 18 is a schematic diagram that illustrates an example in which the user has the locator with him in the house, and the mobile information terminal cannot perform communication through DECT in the locator system according to the present invention;

FIG. 19 is a schematic diagram that illustrates an example of a case where the locator and the base unit can communicate with each other, the base unit and the mobile information terminal can communicate with each other, and the locator and the mobile information terminal can communicate with each other in the locator system according to the present invention;

FIG. 20 is a diagram that illustrates the configuration of a locator provided with a hands-free phone call section;

FIG. 21 is a diagram that illustrates the configuration of a locator provided with a luminance sensor; and

FIG. 22 is a diagram that illustrates the configuration of a locator provided with an angle sensor.

### DESCRIPTION OF EMBODIMENTS

A locator system according to an aspect of the present invention includes: a mobile information terminal that includes a public radio communication section performing radio communication with a public radio network, that includes a GPS position information calculating section that performs position detection using a global positioning system and that includes a near field radio communication unit performing communication with a specific apparatus using a near field radio communication protocol; and a locator that includes a radio communication section performing communication with the mobile information terminal using a near field radio communication protocol. In the locator system: the mobile information terminal performs an operation of calling the locator regularly, performs an operation of detecting a position using the GPS position information calculating section, and stores obtained self-location data in a storage section. The mobile information terminal further includes a notification section that generates a confirmation sound when a normal response is not received from the locator in response to the operation of calling the locator performed by the mobile information terminal, and the mobile information terminal displays position information based on the self-location data stored in the storage section, when an operation for displaying a position is performed.

Accordingly, when the locator becomes far apart from the mobile information terminal, a notification is made using a sound, light, or the like, and the user can promptly recognize that the locator has been lost. In addition, even in a case where a predetermined time or more elapses after the mobile information terminal becomes unable to find the locator, the mobile information terminal records the self-location data before and after being determined that the mobile information terminal cannot find the locator, and accordingly, the location of the locator can be efficiently found using this location detection information.

In addition, according to another configuration, in a case where the mobile information terminal cannot find the locator and in a case where a predetermined operation is not performed even when a predetermined time elapses, the mobile information terminal originates a call toward a predetermined counterpart destination registered in advance through the public radio network, and the counterpart destination is configured to be notified of the self-location data.

Thus, even in a case where the user moves without noticing that the mobile information terminal has been lost, there is a high possibility that the user is notified of the lost before a long time elapses. In addition, the self-location data before and after it is determined that the mobile information terminal cannot be found is transmitted to a terminal located at the user's house or the like without the presence of the mobile information terminal, and accordingly, the user can easily find the mobile information terminal using the location information.

In addition, according to another configuration, when a distance between the mobile information terminal and the locator increases to be in a state in which a calling from the mobile information terminal does not arrive at the locator, the state shifts to a locked state in which the operation of the mobile information terminal is restricted, and a warning is issued from the locator. In addition, the above-described locked state is configured to be released by inputting a password.

Accordingly, in a case where the user having the locator with him becomes far apart from the mobile information terminal, the mobile information terminal shifts to the locked state, and the mobile information terminal is not released from the locked state unless the password is inputted, whereby unauthorized use of the others is prevented.

In addition, according to another configuration, the period of the operation of searching for a signal transmitted from the locator is configured to be controlled so as to be shortened in accordance with an instruction from a user through the public radio network.

With this configuration, even in a state in which the mobile information terminal becomes far apart from the user, and the user cannot directly operate the mobile information terminal, the user originates a call toward the mobile information terminal through the public radio network, and a signal transmitted from the locator is searched at a shortened period, whereby the user having the locator with him can easily find the mobile information terminal.

In addition, according to another configuration, an operation mode of a case where the locator is used as an emergency button is provided, and, as the user operates the input key switch of the locator, a message used for the notification of a state of emergency is configured to be transmitted to the mobile information terminal or the like.

Accordingly, the user having the locator with him can send a message notifying the mobile information terminal, the base unit, or another cordless handset of a state of emergency. Thus, an apparatus receiving this message can perform an operation of originating a call toward a predetermined emergency notification destination (a request for an ambulance, a notification for the police, or any other contact point that is set).

In addition, according to another configuration, a hands-free phone call section is arranged in the locator, and a voice phone call can be made between the locator and the mobile information terminal.

Accordingly, for example, by allowing the mobile information terminal and the locator to be held by different persons at outdoor locations, in a case where the two persons separately act, the persons can be in contact with each other, and accordingly, the state of the other party can be checked.

In addition, according to another configuration, a luminance sensor is arranged in the locator, and the output information of this luminance sensor is configured to be transmitted from the locator to the mobile information terminal.

Accordingly, when the user using the mobile information terminal searches for the locator, information representing whether the location at which the locator is placed is a bright location or a dark location can be acquired, whereby the locator can be easily found.

In addition, according to another configuration, an angle sensor is arranged in the locator, and information representing whether the locator is stopped or the posture thereof is changed is configured to be transmitted to the mobile information terminal.

Accordingly, when the locator is searched for, the user using the mobile information terminal can acquire information representing whether the locator is in the stopped state or in the moving state (for example, the locator is held by another person or is carried in a vehicle, or the like), whereby the locator can be easily found.

Hereinafter, embodiments of the present invention will be described.

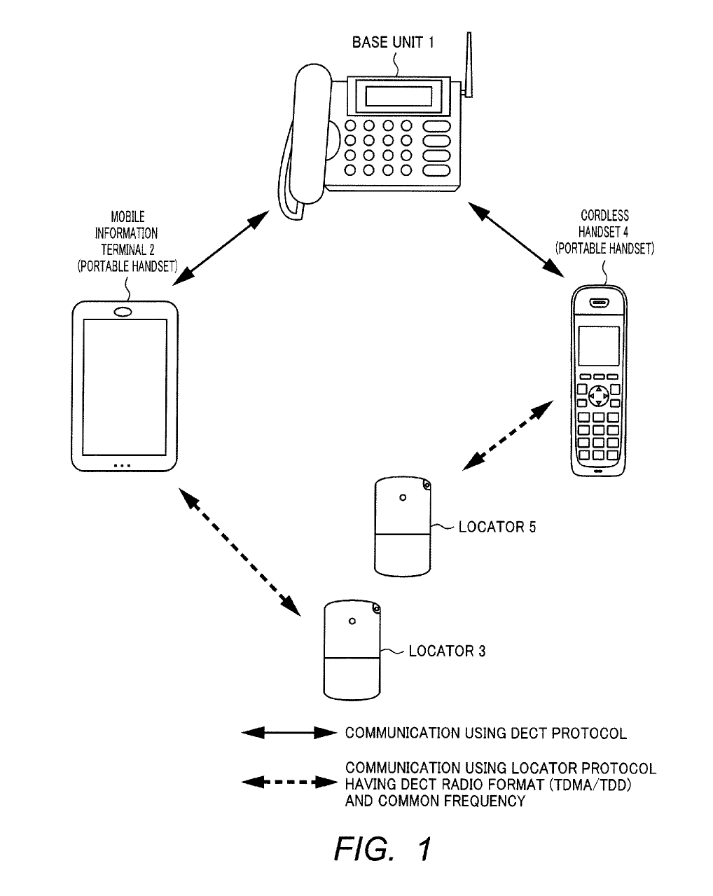

First, an example of the configuration of a radio communication system according to an embodiment of the present invention will be described. FIG. 1 is a diagram that illustrates an example of the radio communication system according to this embodiment.

As illustrated in FIG. 1, the radio communication system is equipped with base unit 1, mobile information terminal 2 that has a function of calling a locator, and locator 3 (and locator 5). The function of calling a locator may be arranged in cordless handset 4 of a codeless telephone used in a house. Here, home radio communication that is compliant with a digital enhanced cordless telecommunications (DECT) standard is performed among base unit 1, mobile information terminal 2 and cordless handset 4. Base unit 1 is a reference for the synchronization of radio communication of the DECT mode, and mobile information terminal 2 and cordless handset 4 operate as slave apparatuses according to the synchronization reference of base unit 1. Locator 3 and locator 5 are slave apparatuses according to the synchronization reference of mobile information terminal 2.

Locator 3 performs near field radio communication with mobile information terminal 2 using a locator protocol to be described later. The locator protocol is a communication protocol used for performing communication of which the radio format and the frequency are in a time division multiple access (TDMA)/time division duplex (TDD) mode. In this embodiment, as an example, a protocol acquired by changing the above-described DECT standard as a base to be appropriate for power saving communication of the locator and the like is used.

Mobile information terminal 2 is a portable communication terminal and, for example, is a mobile information terminal (a personal digital assistant (PDA), a tablet terminal, or the like) that is equipped with a touch panel and is connectable to a cellular phone network and the Internet through a public radio network. By using mobile information terminal 2, a user can perform an operation of calling locator 3. Here, “calling”, for example, is requesting locator 3 to transmit a signal or causing a notification sound to output to locator 3. A signal transmitted to locator 3 for that is a “calling signal.” Mobile information terminal 2 serves also as a handset of the codeless telephone system.

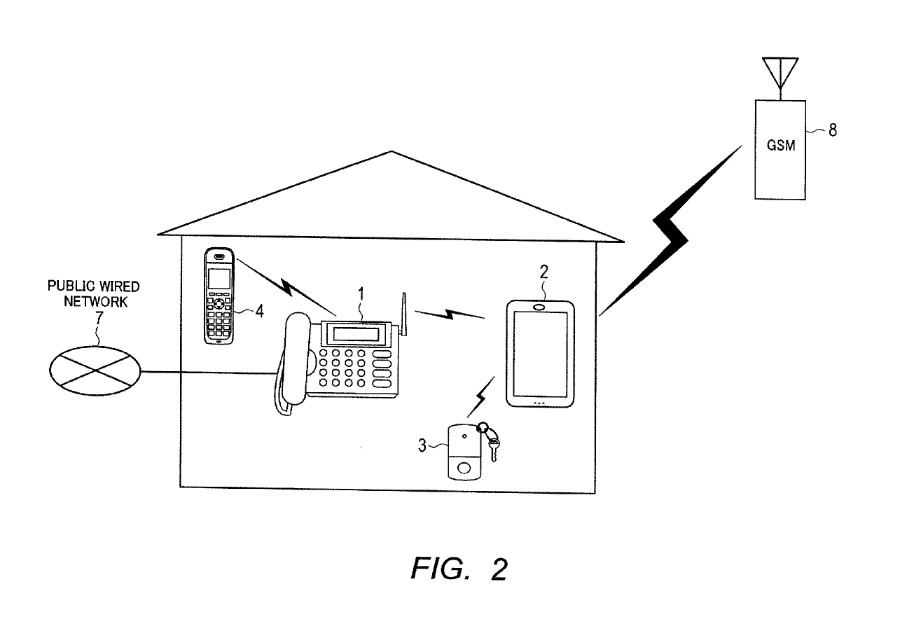

FIG. 2 illustrates the case where both mobile information terminal 2 and locator 3 are located near base unit 1 (for example, inside the house). Base unit 1 is connected to public wired network 7. Mobile information terminal 2 is communicable with a cellular phone network through public radio network 8 and is communicable with base unit 1 through home radio communication using the DECT mode, and mobile information terminal 2 is also communicable with the outside using public wired network 7 through base unit 1.

Locator 3 is a terminal that is attached to an item to be detected by the user. As illustrated in FIG. 2, locator 3, for example, is built in a tag or a holder that is attachable to a key or the like. Mobile information terminal 2 and locator 3 perform near field radio communication using a locator protocol according to this embodiment. Through this radio communication, a calling signal and a response signal are exchanged. In this embodiment, the radio communication between mobile information terminal 2 and locator 3 includes the transmission and reception of a calling signal and a response signal. Locator 3 transmits the response signal in response to the calling signal that has been transmitted from mobile information terminal 2.

Mobile information terminal 2 includes a notification section that detects the signal reception level of a response signal transmitted from locator 3 and issues notification using a sound, light, or the like when the signal reception level is detected to be lower than a predetermined signal reception level value (updated based on learning) for a predetermined period.

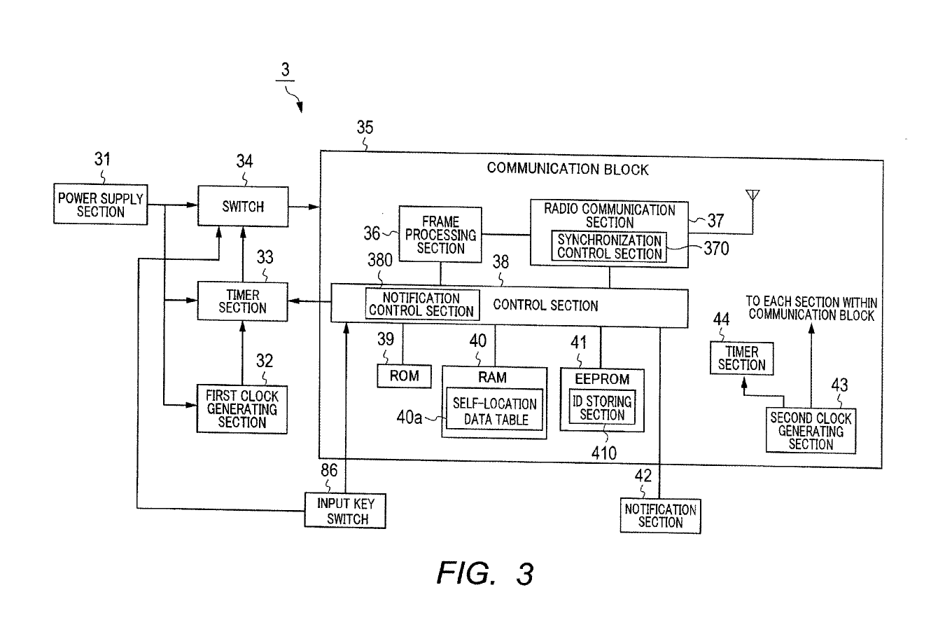

Here, a configuration example of locator 3 will be described. FIG. 3 is a block diagram that illustrates an example of the configuration of locator 3. In addition, locator 5 has the same configuration as the configuration example illustrated in FIG. 3.

As illustrated in FIG. 3, locator 3 includes power supply section 31, first clock generating section 32, timer section 33, switch 34, and communication block 35. In addition, locator 3 includes notification section 42 and input key switch 86.

Communication block 35 includes frame processing section 36, radio communication section 37, control section 38, read only memory (ROM) 39, random-access memory (RAM) 40, electrically erasable programmable read-only memory (EEPROM) 41, second clock generating section 43, and timer section 44. Notification section 42 also serves as various notification sections.

In power supply section 31, a battery as a power source of locator 3 is loaded. For example, the power of locator 3 is turned on by inserting a battery into power supply section 31 and is turned off by taking off the battery from power supply section 31.

First clock generating section 32 generates a clock signal used for operating timer section 33 based on the power that is constantly supplied from power supply section 31. First clock generating section 32, for example, includes a crystal oscillation circuit.

Timer section 33 operates as a first timer. The first timer counts a time period set in advance as a sleep period of communication block 35 and switches switch 34 from the Off state to the On state each time when such a period expires. In other words, timer section 33 is supplied with a low-speed clock from first clock generating section 32 and performs a counting process in accordance with the low-speed clock. Timer section 33 records a value (expiration value) used for determining the sleep period in a register (not illustrated in the drawing) thereof. Then, timer section 33 counts up in accordance with a clock signal transmitted from first clock generating section 32 in a sleep state and ends the counting when the counted value arrives at the expiration value. Then, timer section 33 notifies switch 34 of the end of the counting.

In other words, timer section 33 starts counting by being triggered upon the stop of power supply to communication block 35 (start of the first timer) and counts a predetermined time period during the stop of communication block 35. Then, when the counting ends (the first timer expires), timer section 33 switches switch 34 to the On state and starts supplying power to communication block 35.

In the On state, switch 34 connects communication block 35 to the battery of power supply section 31. On the other hand, in the Off state, switch 34 blocks communication block 35 from the battery of power supply section 31. Locator 3 performs an intermittent reception operation and repeats an operation of returning from a sleep period, performing a reception operation for a predetermined period, and returning to the sleep state at a predetermined period. In accordance with the notification of the end of the counting from timer section 33 described above, switch 34 is switched to the On state from the Off state and starts supplying power to communication block 35.

On the other hand, second clock generating section 43 arranged inside the communication block 35 generates a clock signal used for operating each section of communication block 35 based on the power supplied from power supply section 31 through switch 34. Second clock generating section 43, for example, includes a crystal oscillation circuit. This second clock generating section 43 supplies a high-speed clock signal having a frequency higher than the low-speed clock signal of first clock generating section 32 to each section of communication block 35, and an operation for communication is controlled in accordance with this high-speed clock signal.

Radio communication section 37 receives a calling signal from mobile information terminal 2 using the locator protocol described above and transmits a response signal in response thereto to mobile information terminal 2. Synchronization control section 370 provided in radio communication section 37 determines communication timing of a communication signal according to radio communication section 37 based on a reference clock of second clock generating section 43.

Frame processing section 36 communicates with mobile information terminal 2 through radio communication section 37. Frame processing section 36 includes information to be transmitted in a communication frame, which is compliant with the DECT mode, used for communication with mobile information terminal 2 and performs a process of extracting necessary information from data carried in the communication frame that is compliant with the DECT mode.

In addition, upon reception of a calling signal including an ID of locator 3 (hereinafter, referred to as a “locator ID”) from mobile information terminal 2, frame processing section 36 generates a response signal to be transmitted to mobile information terminal 2. The response signal is transmitted through radio communication section 37. Here, the locator ID is a unique identifier that is assigned in advance.

ROM 39 stores control programs used by control section 38 and various kinds of data therein.

Control section 38 operates based on the clock signal generated by second clock generating section 43, and thereby controlling the overall operation of communication block 35. Control section 38, for example, includes a central processing unit (CPU). Control section 38 executes a control program stored in ROM 39, and thereby performing control for communication with mobile information terminal 2, notification using notification section 42, and reception of various inputs from input key switch 86.

The radio communication between mobile information terminal 2 and locator 3 includes the transmission and reception of a calling signal and a response signal. Locator 3 transmits a response signal in response to a calling signal transmitted from mobile information terminal 2. For example, in a case where a calling signal is received from mobile information terminal 2, control section 38 causes notification section 42 to generate a notification sound. In addition, when an operation of calling mobile information terminal 2 is performed using input key switch 86, the control section 38 performs control of each section such that a calling signal is transmitted to mobile information terminal 2.

Timer section 44 can count a plurality of periods of time separately. For example, timer section 44 operates as a second timer. The second timer starts counting by being triggered upon the reception of a signal from mobile information terminal 2 (start of the second timer) and ends the counting in accordance with the elapse of a predetermined time period (expiration of the second timer). In addition, timer section 44 operates as a third timer. The third timer starts counting by being triggered upon the insertion of the battery into power supply section 31 (start of a third timer) and ends the counting in accordance with the elapse of a predetermined time period (expiration of the third timer).

RAM 40 is a working memory of control section 38.

EEPROM 41 includes ID storing section 410. ID storing section 410 stores a locator ID of locator 3 therein.

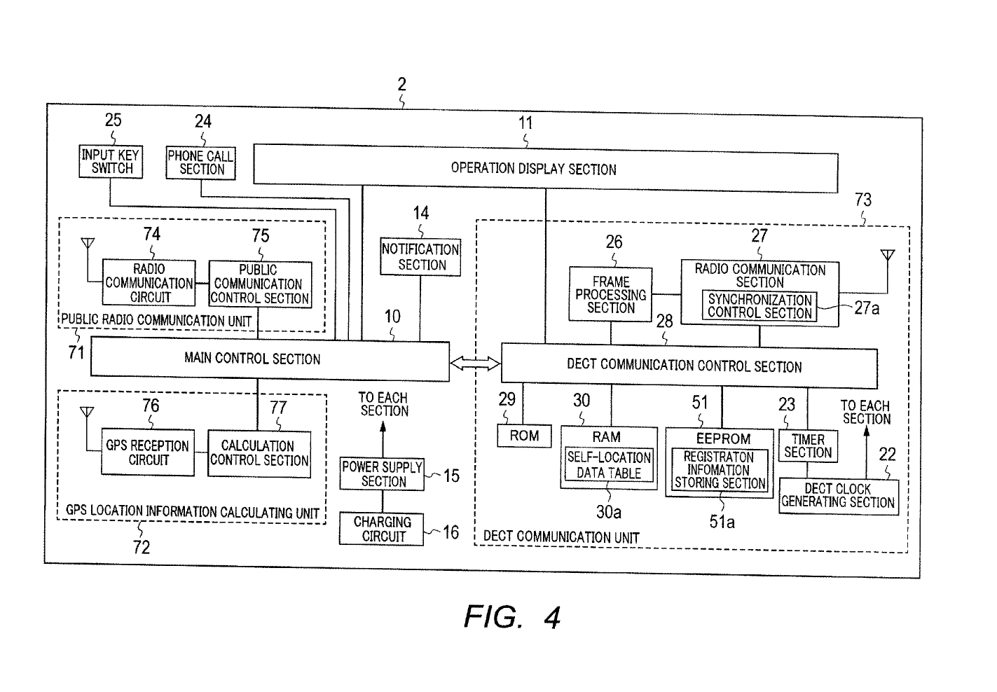

Notification section 42, for example, includes a small speaker, and upon reception of a calling signal from mobile information terminal 2, notification section 42 outputs a notification sound that is used for the notification of the location of locator 3. An example of the notification sound includes a beep sound. In addition, when locator 3 is used in a different monitoring mode, locator 3 monitors whether radio signals transmitted from DECT communication unit 73 (see FIG. 4) of a counterpart apparatus (mobile information terminal 2) are received for each constant time period, and notification section 42 generates a notification sound when a radio signal transmitted from the communication section of the counterpart apparatus is not detected. In this way, by intermittently transmitting and receiving a calling signal and a response signal that are based on the DECT, mobile information terminal 2 and locator 3 can check each other.

Input key switch 86 is provided for inputting an emergency notification or the like and inputting a user instruction for an operation of searching mobile information terminal 2.

Here, the functional sections included in locator 3 are not limited to the functional sections illustrated in FIG. 3, and another functional section may be included as long as locator 3 is configured to transmit and receive a calling signal and a response signal to and from mobile information terminal 2 through TDMA communication. The other functional section may be used for realizing a main function of locator 3 or for realizing an auxiliary function supporting a main function.

Next, a configuration example of mobile information terminal 2 will be described. FIG. 4 is a block diagram that illustrates a configuration example of mobile information terminal 2. As illustrated in FIG. 4, mobile information terminal 2 is equipped with main control section 10 that is configured by a microcomputer as its central constituent member. In addition, operation display section 11 such as a touch panel used for receiving various operations and displaying various states is included therein. Operation display section 11 includes a touch key that is externally exposed and a liquid crystal display. Phone call section 24 includes a microphone, a speaker, a voice amplifier, and the like that are used for making a voice call.

Notification section 14 has a function of an incoming call notification section and a function of generating a confirmation sound, for example, upon the operation of an input key. Notification section 14, for example, includes a small speaker and outputs a notification sound upon reception of a calling signal from base unit 1 and upon reception of a calling signal from public radio network 8.

In addition, mobile information terminal 2 includes three radio communication sections, in other words, public radio communication unit 71, GPS location information calculating unit 72, and DECT communication unit 73 that is based on the DECT.

Public radio communication unit 71 performs radio communication with public radio network 8 using electric waves. GPS location information calculating unit 72 performs location detection using a global positioning system. In addition, DECT communication unit 73 communicates with specific apparatuses such as base unit 1 of a cordless telephone of the DECT mode and locator 3 that are placed mainly in a house.

Mobile information terminal 2 is equipped with power supply section 15 that supplies power to each section and charging circuit 16 that charges power supply section 15, and all of these are housed inside a case having a portable size. Power supply section 15 supplies power used for operating public radio communication unit 71, GPS location information calculating unit 72, and main control section 10 in addition to DECT communication unit 73.

Phone call section 24 is configured by a voice amplifier, a speaker, a microphone, and the like that are used for making a voice call. Input key switch 25 is a key switch that enables an operation input of an emergency notification of the like. When a normal response is not transmitted for the operation of calling locator 3 regularly performed by mobile information terminal 2, an emergency notification using this input key switch 25 can be made.

Public radio communication unit 71 includes radio communication circuit 74 that demodulates a reception signal received by an antenna, outputs received data, and outputs a transmission signal acquired by modulating transmission data toward an antenna and public communication control section 75 that controls the operation of the radio communication circuit.

GPS location information calculating unit 72 is configured by GPS reception circuit 76 that demodulates a reception signal received by the GPS reception antenna and outputs received data and calculation control section 77 that acquires location information through calculation using received information.

Main control section 10 of mobile information terminal 2 constantly monitors an operation input made using operation display section 11 on a processing program mainly based on a microcomputer and performs a process that corresponds to the input. Public radio communication unit 71, GPS location information calculating unit 72, and DECT communication unit 73 are controlled by this main control section 10, and thereby performing transmission/reception of data and the calculation of self-location data.

Operation display section 11 such as a touch panel serves as a user interface (UI) used for receiving various user operations. Operation display section 11, for example, includes a touch panel that is arranged on the surface of the liquid crystal display. As the user operations, a display of a telephone book, a display of an operation menu, and the like are performed in addition to the reception/origination of a phone call, and operations of all the applications as an information terminal are performed by operation display section 11. In addition, an operation (calling operation) for calling locator 3, a display and an operation performed for allowing a user to check the status relating to the operation of locator 3, and the like are performed by this operation display section 11.

DECT communication unit 73 of mobile information terminal 2 includes: DECT clock generating section 22; timer section 23; frame processing section 26; radio communication section 27; DECT communication control section 28; ROM 29; RAM 30, and EEPROM 51.

DECT clock generating section 22, for example, includes a crystal oscillation circuit and generates a clock signal used for operating each section of mobile information terminal 2. Timer section 23 counts a specified time period based on the clock signal transmitted from DECT clock generating section 22.

Radio communication section 27 performs radio communication that is compliant with the digital enhanced cordless telecommunications (DECT) with base unit 1. In addition, radio communication section 27 performs radio communication with the locator by using the locator protocol. For example, radio communication section 27 transmits a calling signal to locator 3 by using the locator protocol and receives a response signal in response thereto from locator 3. Radio communication section 27 includes a radio antenna. Synchronization control section 27a arranged inside radio communication section 27 determines communication timing of a communication signal according to radio communication section 27 based on a reference clock of DECT clock generating section 22.

DECT communication control section 28, for example, includes a CPU and controls a DECT communication operation in corporation with each section. The control process performed by DECT communication control section 28 will be described later.

Frame processing section 26 embeds transmission information in a frame by using a frame configuration matching an operation mode of that moment and transfers the transmission information to radio communication section 27. The frame configuration of DECT is used when communication with base unit 1 is performed, and the frame configuration of the locator is used when communication with locator 3 is performed. When communication with locator 3 is performed, the locator protocol that is partially changed with the DECT mode used as the base in accordance with the use of the locator is used for the communication.

When there is a start operation of receiving a start operation and an end operation of a mode searching for locator 3 (hereinafter, referred to as a “locator mode”) from a user through operation display section 11 such as a touch panel, frame processing section 26 generates a signal using the locator protocol to transmit a calling signal to locator 3 and transmits the calling signal from radio communication section 27 to locator 3. At this time, frame processing section 26 includes identification information of a locator selected by DECT communication control section 28 in the calling signal and transfers the frame configuration to radio communication section 27. In addition, frame processing section 26 includes instruction information that indicates whether there is a notification in the locator selected by DECT communication control section 28 in the calling signal.

ROM 29 stores control programs used by DECT communication control section 28 and various kinds of data therein. RAM 30 and EEPROM 51 are working memories of DECT communication control section 28.

Self-location data table 30a storing self-location data in a time series therein is assigned to RAM 30. The self-location data acquired by GPS location information calculating unit 72 is sequentially recorded in this self-location data table 30a.

Registration information storing section 51a of EEPROM 51 stores an ID of mobile information terminal 2 itself (hereinafter, referred to as a “mobile information terminal ID”), an ID of base unit 1, and an ID of locator 3 therein. The mobile information terminal ID is a unique identifier that is assigned to a mobile information terminal in advance. For example, in a case where a locator ID (an example of the registration information) can be acquired from locator 3 that is a registration counterpart, registration information storing section 51a stores the locator ID therein.

Here, the functional section included in mobile information terminal 2 is not limited to the functional section illustrated in FIG. 3, but other functional sections may be included therein. The other functional sections may be used either for realizing main functions of mobile information terminal 2 or for realizing auxiliary functions supporting the main functions.

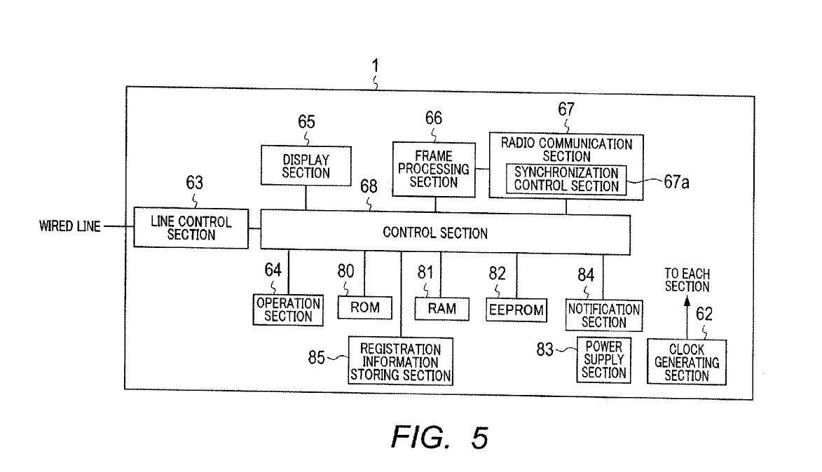

Next, a configuration example of base unit 1 will be described. FIG. 5 is a block diagram that illustrates the configuration example of base unit 1. As illustrated in FIG. 5, base unit 1 is equipped with clock generating section 62, line control section 63, operation section 64, display section 65, frame processing section 66, radio communication section 67, control section 68, ROM 80, RAM 81, and EEPROM 82. In addition, base unit 1 is equipped with power supply section 83, notification section 84, and registration information storing section 85.

Power supply section 83 supplies power that is used for operating base unit 1. Clock generating section 62 generates a clock signal used for operating each section of base unit 1 based on the power that is supplied from power supply section 83. Clock generating section 62, for example, includes a crystal oscillation circuit. Line control section 63 communicates with a wired telephone network.

Operation section 64 includes buttons used for receiving various user operations. Display section 65, for example, includes a liquid crystal display and, for example, displays a telephone number, an operation menu of base unit 1, and the like.

Frame processing section 66 embeds frame transmission information matching an operation mode of that moment into the frame and transfers the frame transmission information to radio communication section 67. The frame configuration of DECT is used when communication with mobile information terminal 2 is performed, and the frame configuration of the locator is used when communication with locator 3 is performed.

Radio communication section 67 performs radio communication with mobile information terminal 2 and another cordless handset using the TDMA/TDD mode. In this embodiment, radio communication section 67 performs radio communication, for example, using the DECT protocol. Synchronization control section 67a provided in radio communication section 67 determines communication timing of a communication signal according to radio communication section 67 based on the reference clock of clock generating section 62.

Control section 68 includes a CPU and controls the overall operation of base unit 1 in cooperation with the above-described sections. ROM 80, for example, stores control programs used by control section 68 and various kinds of data therein. RAM 81 and EEPROM 82 are working memories of control section 68.

Notification section 84, for example, includes a small speaker and outputs a notification sound when a calling signal is received from line control section 63. Registration information storing section 85 stores the ID of each terminal, that is, mobile information terminal 2, which is a communication counterpart, an ID of another cordless handset, and an ID of locator 3 therein in addition to the ID of base unit 1.

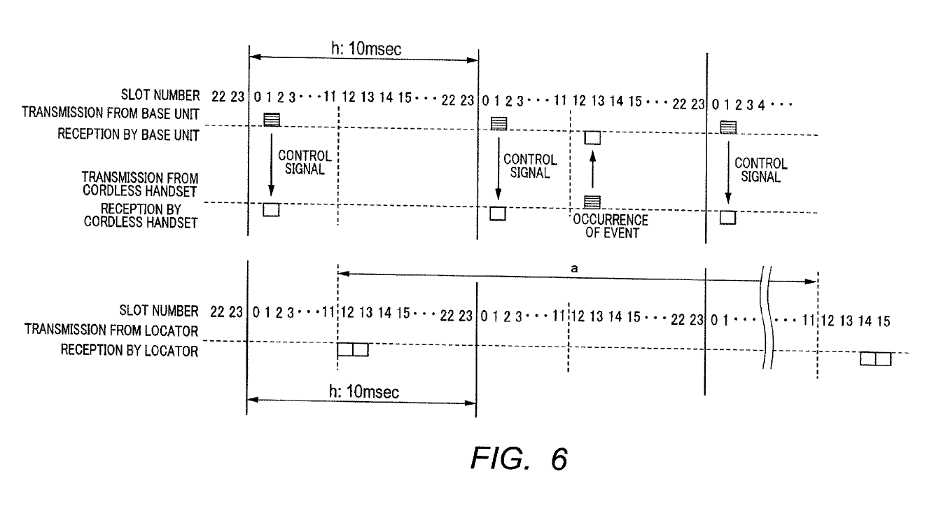

Next, a configuration example of a communication frame in TDMA communication used in this embodiment will be described with reference to FIG. 6. FIG. 6 illustrates an example of TDMA communication performed between base unit 1 and a cordless handset (or a mobile information terminal) in the normal state.

In radio communication according to DECT, for example, as illustrated in FIG. 6, a time division mode is used in which communication is performed by setting 10 msec as one frame and dividing one frame into 24 slots. Base unit 1 transmits the base unit ID using a control signal, and the cordless handset (or mobile information terminal 2) acquires the base unit ID while receiving the control signal, compares the acquired base unit ID with the ID of a base unit (registered base unit) for which mobile information terminal 2 stands by, and selects a base unit to be synchronized with.

In addition, at the standby time, the cordless handset (or mobile information terminal 2) transmits nothing to base unit 1 for every frame, and transmission from the cordless handset (or mobile information terminal 2) to base unit 1 is performed only when an event such as an outgoing call occurs and a phone call state is made. In such a case, the cordless handset (or mobile information terminal 2) selects one slot and performs communication using upstream and downstream slots thereof.

Base unit 1 constantly transmits a control signal in a predetermined slot for each frame. A control signal serving as a synchronization signal includes synchronization data (for example, Syncword). The Syncword is a known digit sequence determined in advance for timing synchronization and is synchronization information used for the synchronization of mobile information terminal 2. The reception side starts cutting out and taking in a frame at a time point when this known digit sequence is found.

In the DECT mode, a unique Syncword is assigned to each network, and the Syncword is included to signals transmitted from terminals in common.

At the time of standby, locator 3 does not receive a control signal from base unit 1 and is not synchronized with base unit 1. Locator 3, at the time of standby, performs a reception operation during time corresponding to two slots regularly and independently and waits for a signal transmitted from mobile information terminal 2 or base unit 1. In a case where the signal transmitted from mobile information terminal 2 or base unit 1 is received, locator 3 performs communication according to the locator protocol to be described later in synchronization with mobile information terminal 2 or base unit 1. The method used for the synchronization of locator 3 is same as above, and, for example, Syncword is included in a locator calling signal transmitted from mobile information terminal 2, and the locator can be synchronized with mobile information terminal 2.

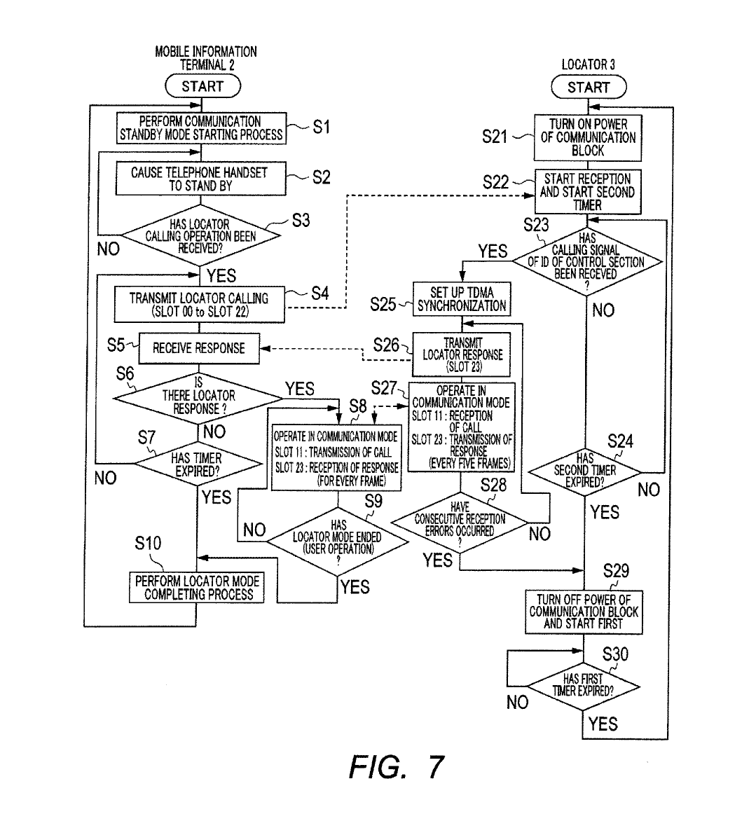

Next, an example of the operation of the locator system described above will be described. FIG. 7 is a flowchart that illustrates an example of a locator search operation in which mobile information terminal 2 searches for a locator in this locator system.

In Step S1, DECT communication control section 28 of DECT communication unit 73 of mobile information terminal 2 that has been supplied with power and has started the operation starts a communication standby mode. In the communication standby mode, mobile information terminal 2 can generate an outgoing call toward the public wired network through base unit 1 and receive an incoming call from the public wired network, thereby proceeding to a phone call with another telephone set through the outgoing call or the incoming call.

In Step S2, DECT communication control section 28 instructs radio communication section 27 to receive a control signal from base unit 1 and controls mobile information terminal 2 to be in a standby state of base unit 1.

In Step S3, DECT communication control section 28 determines whether or not operation display section 11 such as a touch panel has received an operation of calling a locator. In a case where operation display section 11 such as a touch panel has not received an operation of calling a locator (No in Step S3) as a result of the determination made in Step S3, the flow is returned to Step S2. On the other hand, in a case where operation display section 11 such as a touch panel has received an operation of calling a locator (Yes in Step S3) as a result of the determination made in Step S3, a locator calling mode is started, and the flow proceeds to Step S4. In addition, a timer used for defining a time limit during which the locator calling mode lasts in timer section 23 is started in accordance with the operation of calling the locator.

In Step S4, DECT communication control section 28 transmits a locator calling signal used for calling locator 3 (outputting a notification sound from locator 3) from radio communication section 27. In addition, DECT communication control section 28 starts timer section 23 by being triggered upon the transmission of the locator calling signal. Accordingly, timer section 23 starts counting a time period set in advance. In the locator calling signal, a locator ID representing a locator that is a calling target is included.

Meanwhile, locator 3 operates as follows.

In Step S21, power is input to communication block 35, for example, by inserting a battery.

In Step S22, control section 38 of locator 3 instructs radio communication section 37 to start a reception operation. In addition, a second timer is started by timer section 44 that counts high-speed clock signals supplied from second clock generating section 43 by being triggered by radio communication section 37 starting the reception of a locator calling signal. In accordance with the start of the second timer, locator 3 is in a state in which a signal transmitted from mobile information terminal 2 can be received. In addition, control section 38 instructs radio communication section 37 to receive a locator calling signal transmitted from mobile information terminal 2.

In Step S23, control section 38 determines whether or not a locator calling signal including the ID thereof has been received. In a case where a locator calling signal including the ID has not been received as a result of the determination made in Step S23 (No in Step S23), the flow proceeds to Step S24. On the other hand, in a case where a locator calling signal including the ID has been received as a result of the determination made in Step S23 (Yes in Step S23), the flow proceeds to Step S25.

In Step S24, control section 38 determines whether or not the second timer has expired. In a case where the second timer has not expired (No in Step S24) as a result of the determination made in Step S24, the flow is returned to Step S23. On the other hand, in a case where the second timer has expired (Yes in Step S24) as a result of the determination made in Step S24, the flow proceeds to Step S29.

In a case where a locator calling signal including the above-described ID has been received (Yes in Step S23), in Step S25, control section 38 sets up TDMA synchronization with mobile information terminal 2 that is a transmission source of the locator calling signal through radio communication section 37.

In Step S26, control section 38 transmits a locator response signal from radio communication section 37 by instructing radio communication section 37 to transmit the locator response signal that is a response to the locator calling signal.

Again, returning to the operation of mobile information terminal 2, after the locator calling signal is transmitted, mobile information terminal 2 operates as follows.

In Step S5, mobile information terminal 2 performs the process of receiving a response from locator 3 until the timer of timer section 23 expires.

In Step S6, DECT communication control section 28 of mobile information terminal 2 determines whether or not radio communication section 27 has received the locator response signal from locator 3. In a case where radio communication section 27 has not received the locator response signal (No in Step S6) as a result of the determination made in Step S6, the flow proceeds to Step S7. On the other hand, in a case where radio communication section 27 has received the locator response signal (Yes in Step S6) as a result of the determination made in Step S6, the flow proceeds to Step S8.

In Step S7, DECT communication control section 28 determines whether or not the timer of timer section 23 has expired. In a case where the timer of timer section 23 has not expired (No in Step S7) as a result of the determination made in Step S7, the flow is returned to Step S4. On the other hand, in a case where the timer of timer section 23 has expired (Yes in Step S7) without receiving the locator response signal as a result of the determination made in Step S7, the flow proceeds to Step S10.

In Step S8, according to the locator protocol described above, mobile information terminal 2 serves as a synchronization master, locator 3 receives the locator calling signal transmitted from mobile information terminal 2, and mobile information terminal 2 receives the locator response signal transmitted from locator 3.

In Step S9, DECT communication control section 28 determines whether or not operation display section 11 such as a touch panel has received an operation of ending the locator calling mode. In a case where the operation of ending the calling mode has not been received by operation display section 11 such as a touch panel (No in Step S9) as a result of the determination made in Step S9, the flow is returned to Step S8. On the other hand, in a case where the operation of ending the calling mode has been received by operation display section 11 such as a touch panel (Yes in Step S9) as a result of the determination made in Step S9, the flow proceeds to Step S10.

In Step S10, DECT communication control section 28 performs the process of ending the locator calling mode.

Again, returning to the operation of locator 3, after the locator response signal is received in Step S26, locator 3 operates as follows.

In Step S27, locator 3 receives a locator calling signal and transmits a locator response signal in synchronization with mobile information terminal 2 in accordance with the locator protocol.

In Step S28, control section 38 of locator 3 monitors whether or not consecutive reception errors occur. In a case where consecutive reception errors do not occur (No in Step S28) as a result of the monitoring performed in Step S28, the flow is returned to Step S26. On the other hand, in a case where consecutive reception errors occur (Yes in Step S28) as a result of the monitoring performed in Step S28, the flow proceeds to Step S29. In addition, when the second timer expires as described above (Yes in Step S24), the flow proceeds to Step S29.

In Step S29, control section 38 blocks the power supplied to communication block 35. As a result, the communication operation of locator 3 is stopped. In locator 3, the first timer is started by timer section 33, which counts low-speed clock signals supplied from first clock generating section 32, by being triggered upon the blocking of the power supplied to communication block 35. Thereafter, the first timer counts up while the communication operation of locator 3 is stopped.

In Step S30, control section 38 determines whether or not the first timer has expired. In a case where the first timer has not expired (No in Step S30) as a result of the determination made in Step S30, control section 38 performs the determination of Step S30 again. On the other hand, in a case where the first timer has expired (Yes in Step S30) as a result of the determination made in Step S30, control section 38 returns the process again to Step S21.

Then, in Step S21, when power is input to communication block 35, control section 38 instructs radio communication section 37 to start a reception operation in Step S22. Thereafter, the above-described operations of Step S23 and subsequent steps are performed again.

In this way, by the operation of calling the locator using operation display section 11 such as a touch panel of mobile information terminal 2, mobile information terminal 2 communicates with locator 3 by radio using the locator protocol. In addition, locator 3 can receive the locator calling signal transmitted from mobile information terminal 2 by performing a reception operation regularly using the counting of the first timer. In such a case, locator 3 corrects communication timing in accordance with the timing of receiving a control signal from mobile information terminal 2 in synchronization with a control signal transmitted from mobile information terminal 2, which is the master.

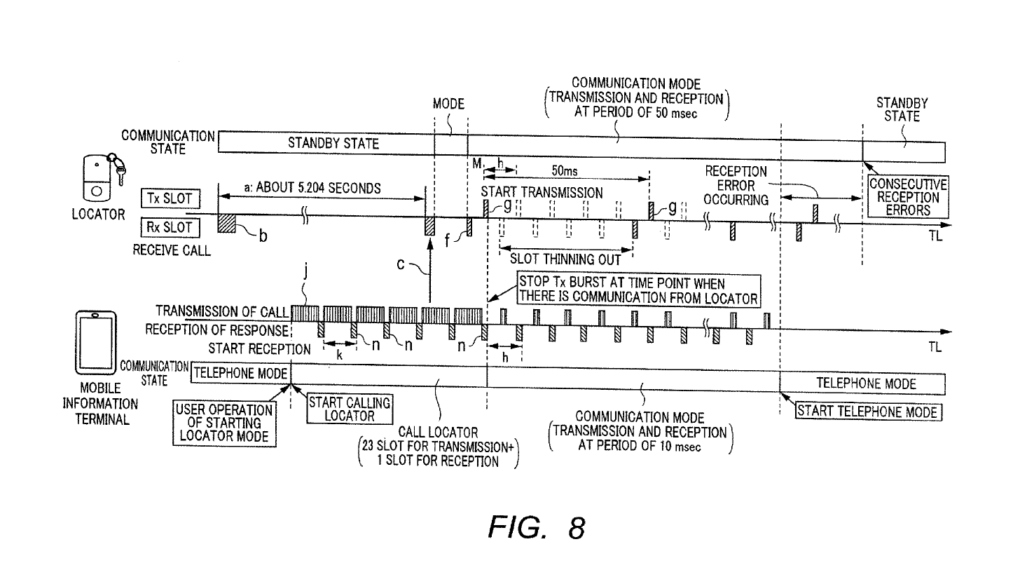

FIG. 8 is a timing diagram that illustrates communication operations of the mobile information terminal and the locator. Hereinafter, an example of the operation performed when mobile information terminal 2 calls locator 3 in the above-described locator system will be described with reference to FIG. 8

In FIG. 8, TL represents the time axis, and the time is assumed to advance from the left side to the right side in the drawing. In each drawing, the upper side of the time axis TL represents a transmission slot (or a transmission signal) and the lower side of the time axis TL represents a reception slot (or a reception signal).

First, for example, when a battery is inserted into power supply section 31, locator 3 proceeds to be in a state (call standby state) of standing by for the reception of a calling signal transmitted from mobile information terminal 2. At this time, as illustrated in FIG. 8, control section 38 controls radio communication section 37 so as to receive a calling signal using reception slot b and controls timer section 33 so as to start period a.

Timer section 33 counts low-speed clock signals generated by first clock generating section 32. When the counted value of timer section 33 increases to an expiration value, switch 34 is switched from the Off state to the On state. Through this switching, the supply of power to radio communication section 37 is started. Then, radio communication section 37 starts an operation so as to receive a calling signal using reception slot b.

Next, the operation at the time when a calling operation for calling locator 3 is performed in mobile information terminal 2 will be described.

In the case illustrated in FIG. 8, when operation display section 11 such as a touch panel of mobile information terminal 2 receives a calling operation, DECT communication control section 28 starts timer section 23 and performs control such that calling signals j corresponding to a predetermined number of slots are consecutively transmitted from radio communication section 27, first. Then, after calling signals j are transmitted until timer section 23 completes the counting of time determined in advance, DECT communication control section 28 stands by for the reception of a response signal using a reception slot n. Then, a time period k from the start of transmission of calling signals j to the standby for the reception of a response signal using the reception slot n is repeated.

DECT communication control section 28 of mobile information terminal 2 transmits a calling signal during a predetermined time period (for example, time period e). However, radio communication section 27 is controlled so as to perform a reception operation not continuously but regularly during period k for only one slot (slot n) and to perform a reception standby operation for receiving a response signal from locator 3. In a case where a response signal cannot be received from locator 3 in a normal way, DECT communication control section 28 performs control such that the transmission of calling signal j and the reception standby for a response signal are repeated during time period k until the response signal is received from locator 3.

When a calling signal (C in FIG. 8) in one slot within calling signal j can be received, locator 3 can receive reception timing information transmitted from mobile information terminal 2 with being carried in this calling signal. Locator 3 determines a transmission slot (slot n) used for transmitting a response signal based on this reception timing information and starts to prepare the transmission of a response signal. Then, locator 3 transmits the response signal using slot n.

When the response signal that is transmitted using slot n from locator 3 is received by mobile information terminal 2, DECT communication control section 28 stops the consecutive transmission of calling signals j by being triggered upon the reception of this response signal. Thereafter, a control signal that is transmitted regularly by mobile information terminal 2 is received by locator 3, and locator 3 transmits a signal to mobile information terminal 2 regularly, whereby synchronization is taken. Locator 3 transmits a response signal using transmission slot g, and the response signal is received by mobile information terminal 2.

In a case where a response signal is not received until timer section 23 ends counting of a time (for example, constant time e) set in advance, DECT communication control section 28 stops the transmission of calling signal j and the reception waiting for a response signal.

As described above, DECT communication control section 28 of mobile information terminal 2 transmits a calling signal during a predetermined time period (for example, constant time e), but not consecutively, performs a reception operation regularly only for one slot during period k (slot n), and controls radio communication section 27 so as to perform a reception standby operation for receiving a response signal from locator 3. In a case where a response signal cannot be received from locator 3 in a normal way, DECT communication control section 28 performs control such that the transmission of calling signal j and the reception standby for a response signal are repeated in time period k until a response signal is received from locator 3.

In FIG. 8, h is 10 ms that is the same as the period of one frame of DECT. In the case illustrated in FIG. 8, after time point M, DECT communication control section 28 performs control such that the transmission of a calling signal and the reception of a response signal are repeatedly performed at the interval of h (10 ms). Locator 3 performs control such that the reception of a calling signal and the transmission of a response signal are repeatedly performed at the interval of 10 ms in synchronization with mobile information terminal 2.

As illustrated in FIG. 8, when locator 3 can receive calling signal c in one slot within calling signal j, and mobile information terminal 2 can receive a response signal transmitted thereafter from locator 3 using slot n, by stopping the consecutive transmission of calling signals j by being triggered upon the reception of this response signal, unnecessary transmission of a calling signal is prevented.

As above, the example of the operation when mobile information terminal 2 calls locator 3 in the locator system according to this embodiment has been described.

### Example 1

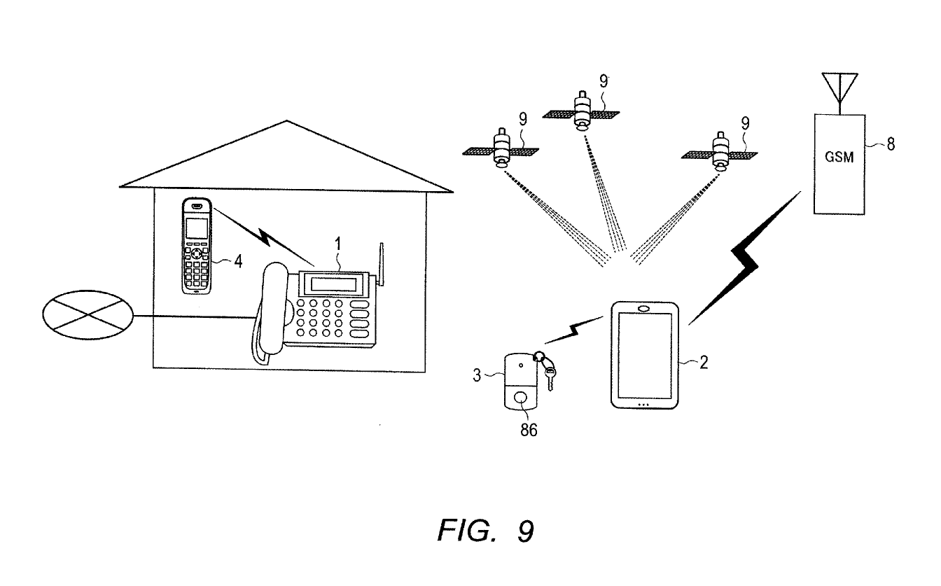

Next, an operation performed in a “constant locator monitoring mode” in which mobile information terminal 2 monitors locator 3 regularly will be described. FIG. 9 illustrates the case where a user takes out mobile information terminal 2 and locator 3 together outside the house.

When an operation of monitoring locator 3 is started by operation display section 11 of mobile information terminal 2, main control section 10 of mobile information terminal 2 performs the process of Step S4 regularly and the subsequent steps illustrated in FIG. 7 at a predetermined time period (for example, one minute) by operating DECT communication unit 73, thereby transmitting a locator calling signal. During this monitoring operation, mobile information terminal 2 transmits a locator calling signal in a channel that is receivable for locator 3 and stands by for a response signal transmitted from locator 3.

In addition, in a case where GPS location information calculating unit 72 is operated in mobile information terminal 2, GPS location information calculating unit 72 generates data of current location coordinates (self-location data) by performing calculation using information transmitted from GPS satellite 9. When GPS location information calculating unit 72 is operated in parallel with the monitoring operation, the self-location data of mobile information terminal 2 that is generated by GPS location information calculating unit 72 is transmitted to main control section 10. At timing at which DECT communication unit 73 transmits a locator calling signal regularly, main control section 10 sequentially records the self-location data at that time in self-location data table 30a.

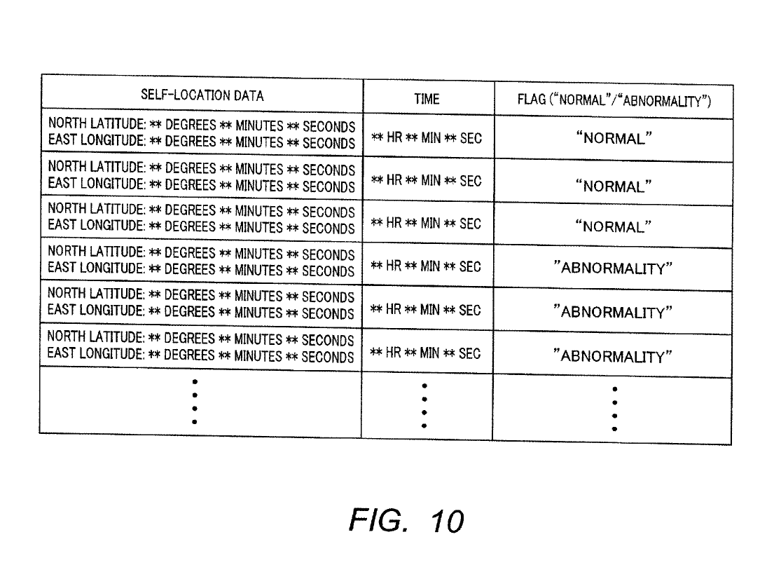

FIG. 10 illustrates an example of information that is recorded in self-location data table 30a. Main control section 10, as illustrated in FIG. 10, records time at which location information is acquired and a flag (“normal”/“abnormality”) that represents whether a response signal can be received in a normal way, which will be described later, in self-location data table 30a together with the self-location data.

Hereinafter, the control process for sequentially recording the self-location data in self-location data table 30a will be described in detail.

When a response signal is transmitted from locator 3 in a normal way within a predetermined time in response to the one-time transmission of a locator calling signal, the step of the transmission of a calling signal at the time ends, and DECT communication unit 73 is caused to be in the sleep state until the next time period. In addition, self-location data at a time point at which a response signal is transmitted in a normal way is recorded in self-location data table 30a together with the flag of “normal.”

In a case where a response signal in response to a locator calling signal cannot be received in a normal way or a case where the signal reception level of the response signal does not reach a threshold (updated based on learning), DECT communication unit 73 repeats the transmission of a locator calling signal with the period at which a locator calling signal is transmitted (for example, every 10 seconds) being advanced. In addition, in such a case, a flag representing “abnormality” is attached to the self-location data recorded in self-location data table 30a.

In this way, the self-location data recorded in self-location data table 30a of mobile information terminal 2 is recorded in a time series being attached with the flag of “normal” or the flag of “abnormality,” and in a case where mobile information terminal 2 is in a missing state of being far apart from locator 3, the data recorded in self-location data table 30a includes at least most recent self-location data at the time when a signal transmitted from the locator is not detected and self-location data at the time when a signal transmitted from the locator is detected most recently.

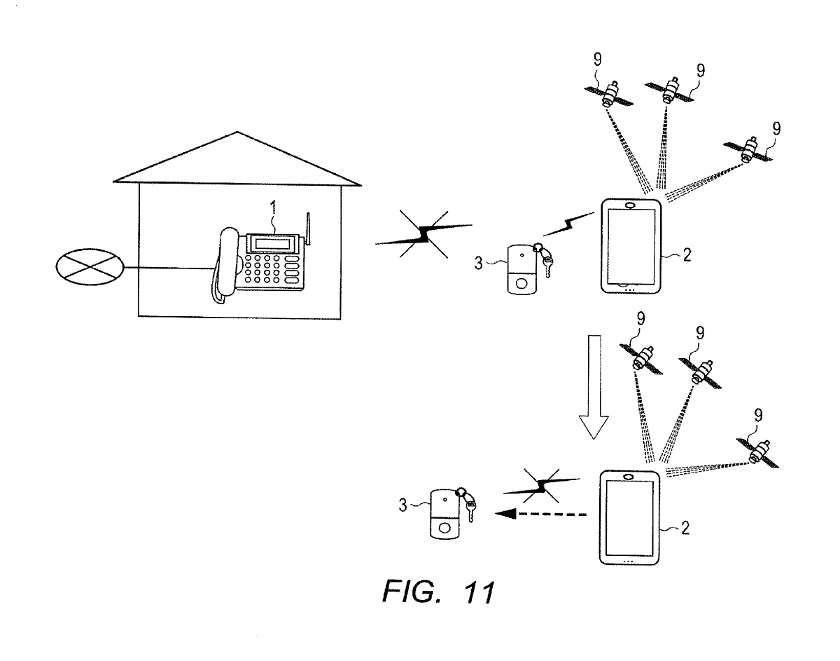

FIG. 11 illustrates an example of a case where mobile information terminal 2 and locator 3 are far apart from each other, and a user has mobile information terminal 2 with him and drops locator 3 at a place. In self-location data table 30a, information of latest location data and time when a response signal in response to a locator calling signal is received in a normal way and information of self-location data and time when a response signal cannot be received in a normal way thereafter are recorded.

In a case where the state in which a response signal in response to a terminal calling signal is not transmitted in a normal way is continued for a predetermined time (for example, 30 seconds), main control section 10 of mobile information terminal 2 recognizes that the missing state of being far apart from locator 3 is formed and performs control such that a confirmation sound is generated using voice. When the confirmation sound of mobile information terminal 2 can be heard, the user can check the location of locator 3 at that time point. Thus, for example, in a case where locator 3 is placed at a location at which the propagation of electric waves is bad, and the user notices it, by operating mobile information terminal 2 to be reset, the user resolves the situation.

When the user cannot hear the confirmation sound, or when a predetermined time elapses without mobile information terminal 2 being reset described above, there is a high possibility of locator 3 being lost.

The user recognizes locator 3 being lost and performs an operation of starting a search operation in the mobile information terminal 2, whereby the following search operation is started.

Mobile information terminal 2 estimates a location at which the lost state is formed based on the self-location data of the “normal” flag and the self-location data of the “abnormality” flag that are recorded in self-location data table 30a and generates an URL of a map on which a time point at which the lost state is formed and the estimated location are located on the center. Mobile information terminal 2 downloads a map based on the URL and displays the map on operation display section 11.

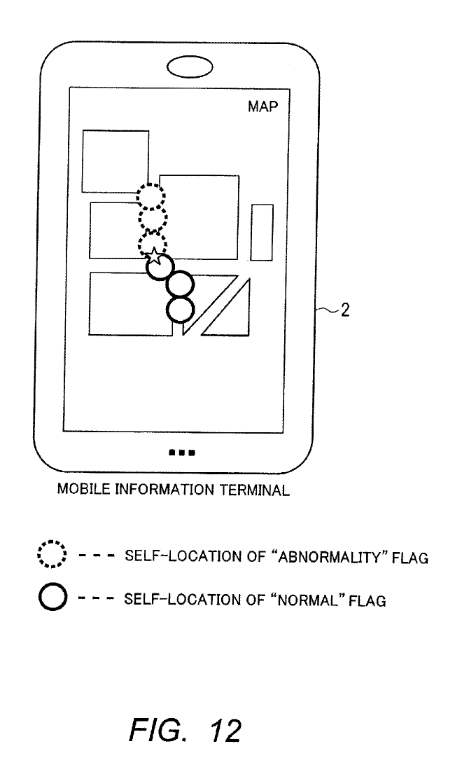

FIG. 12 illustrates an example of displaying a map on mobile information terminal 2 based on the above-described URL after mobile information terminal 2 and locator 3 become far apart from each other. By simultaneously plotting a self-location relating to the “normal” flag and a self-location relating to the “abnormality” flag on the map, the user can easily estimate a location at which locator 3 is lost.

In addition, mobile information terminal 2 acquires a time point at which the lost state is formed and the estimated location through calculation based on the self-location data of the “normal” flag and the self-location data of the “abnormality” flag that are recorded in self-location data table 30a, downloads a map based on the above-described URL, and can display the map on operation display section 11, and display by plotting a location (for example, a “star” mark illustrated in FIG. 12) represented by the “lost location data” acquired through the calculation on the map.

It is preferable that main control section 10 appropriately set a first threshold level while averaging the reception levels of signals transmitted from locator 3 at a predetermined time interval. In a case where the reception level of the signal transmitted from locator 3 is the first threshold level that is appropriately set or less, the time period at which locator calling signals are transmitted is advanced, and, in a case where the reception level is recovered to be the first threshold level or more within a predetermined time, the time period at which a calling signal is transmitted is returned to its original value, whereby unnecessary notifications can be prevented from being frequently issued.

In addition, by appropriately setting a second threshold level that is lower than the first threshold level, in a case where the reception level of a signal transmitted from locator 3 suddenly falls to be the second threshold level or less, a confirmation sound is immediately generated without waiting for a predetermined time (for example, 30 seconds described above), whereby the user can check the location before completely missing locator 3.

In addition, in a case where the missing state of being far apart from locator 3 is recognized, based on the setting, mobile information terminal 2 can originate a call toward a predetermined counterpart destination through public radio network 8. The predetermined counterpart destination, for example, may be base unit 1 of a house that is connected to a fixed telephone network. Furthermore, mobile information terminal 2 may transmit location detection information detected by GPS location information calculating unit 72 through communication with the counterpart destination.

The transmission/reception circuit of locator 3 is supplied with power only at timing when a calling signal is transmitted from mobile information terminal 2, and the power supply is stopped at the other timing points. In addition, in mobile information terminal 2, normally, while GPS location information calculating unit 72 is in the sleep mode having low power consumption, when the monitoring operation for locator 3 is started, GPS location information calculating unit 72 is operated at necessary timing.

In a case where the operation of GPS location information calculating unit 72 has a strong influence on the power consumption of mobile information terminal 2, instead of constantly operating GPS location information calculating unit 72, mobile information terminal 2 may operate GPS location information calculating unit 72 when the reception signal level of the communication that is based on the DECT described above is the predetermined threshold level or less. For example, by operating GPS location information calculating unit 72 only in a case where the reception level of a signal transmitted from locator 3 is the first threshold level, which is appropriately set, or less, the calculation of the location is not constantly performed, and the power consumption for the calculation of the location can be reduced.

In addition, in the example described above, while the self-location data is stored in self-location data table 30a, a configuration may be employed in which a service company center office C is notified of the self-location data through a cellular phone base station, and the service company manages the self-location data. In such a case, when there is a request from the user, the service company center office C can specify the location of mobile information terminal 2 that has been lost based on the detected location information, and accordingly, the collection operation thereof can be performed promptly.

In other words, in accordance with a request from mobile information terminal 2, based on the self-location data of the “normal” flag and the self-location data of the “abnormality” flag that have been recorded, service company center office C estimates the location at a time point when the lost state is formed, acquires a time point at which the lost state is formed and location data of the estimated location, “lost location data” through calculation, and generates a URL of a map on which this “lost location data” is positioned on the center. Mobile information terminal 2 downloads a map based on the URL transmitted from the service company and plots a location representing the “lost location data” on the map.

In a case where a locator calling signal to be transmitted from DECT communication unit 73 of mobile information terminal 2 at a predetermined period cannot be received by locator 3, a confirmation sound can be generated from notification section 42 of locator 3. However, the confirmation sound transmitted from locator 3 may be configured not to be generated based on the setting.

### Example 2

Next, a mode (hereinafter, referred to as an “information terminal monitoring mode”) in which a user having the locator with him constantly monitors the presence of mobile information terminal 2 will be described.

When a user using mobile information terminal 2 has mobile information terminal 2 and locator 3 with him, mobile information terminal 2 and locator 3 are present within a predetermined ranged, and accordingly, communication therebetween is not disconnected. However, when mobile information terminal 2 becomes far apart from the user's body and is in a state in which a periodic calling from mobile information terminal 2 does not reach the user, a warning is generated from mobile information terminal 2, and lost or theft of mobile information terminal 2 can be noticed.

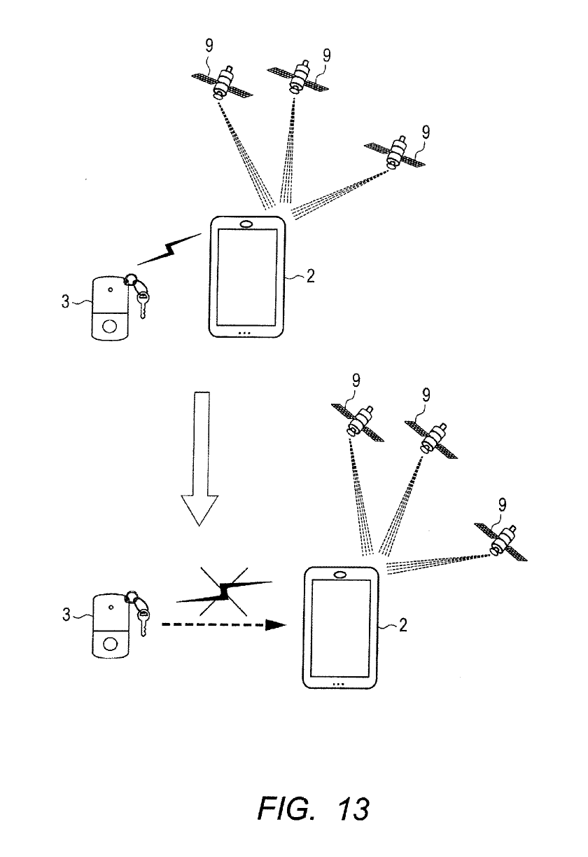

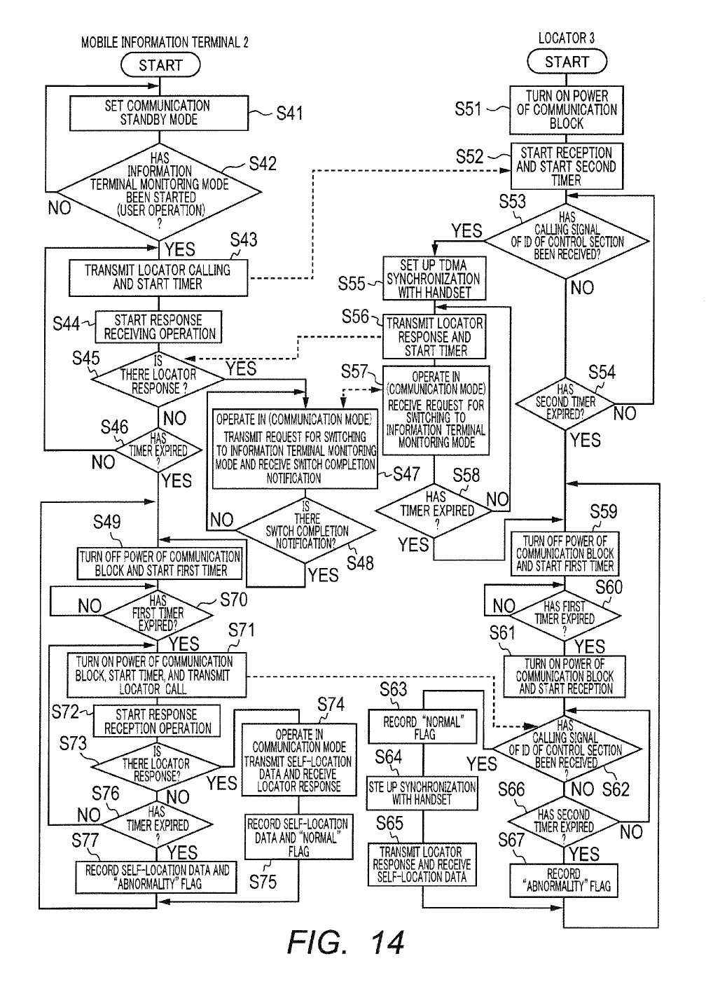

FIG. 13 illustrates an example of a case where mobile information terminal 2 becomes far apart from the user having locator 3 with him. More specifically, for example, an example is illustrated in which mobile information terminal 2 is lost inside a vehicle. FIG. 14 is a flowchart that illustrates an example of the operation performed in this locator system in the information terminal monitoring mode.

In Step S41, when the operation is started by inputting the power, a communication standby mode operates, and accordingly, mobile information terminal 2 can originate a call toward the public wired network through base unit 1 and receive an incoming call from the public wired network.

In Step S42, DECT communication control section 28 determines whether or not operation display section 11 such as a touch panel has received an operation of calling a locator. In a case where operation display section 11 such as a touch panel has not received an operation of starting the information terminal monitoring mode (No in Step S42) as a result of the determination made in Step S42, the communication standby mode is maintained. On the other hand, in a case where operation display section 11 such as a touch panel has received an operation of starting the information terminal monitoring mode (Yes in Step S42) as a result of the determination made in Step S42, the information terminal monitoring mode is started, and the flow proceeds to Step S43.

In Step S43, DECT communication control section 28 transmits a locator calling signal used for calling locator 3 from radio communication section 27. In addition, in accordance with an operation of starting the monitoring mode, timer section 33 starts a timer that is used for defining a time limit during which a locator calling is continued. From this, timer section 23 starts counting of time that is determined in advance. In the locator calling signal, a locator ID representing a locator that is a calling target is included.

Meanwhile, locator 3 operates as follows. In Step S51, power is input to communication block 35, for example, by inserting a battery. In Step S52, control section 38 of locator 3 instructs radio communication section 37 to start a reception operation so as to receive a locator calling signal transmitted from mobile information terminal 2. In addition, a second timer is started by timer section 44 that counts high-speed clock signals supplied from second clock generating section 43 by being triggered upon the start of the reception operation. In accordance with the start of this second timer, locator 3 is in a state in which a signal transmitted from mobile information terminal 2 can be received.

In Step S53, control section 38 determines whether or not a locator calling signal including the ID thereof has been received. In a case where a locator calling signal including the ID has not been received as a result of the determination made in Step S53 (No in Step S53), the flow proceeds to Step S54. On the other hand, in a case where a locator calling signal including the ID has been received as a result of the determination made in Step S53 (Yes in Step S53), the flow proceeds to Step S55.

In Step S54, control section 38 determines whether or not the second timer has expired. In a case where the second timer has not expired (No in Step S54) as a result of the determination made in Step S54, the flow is returned to Step S53. On the other hand, in a case where the second timer has expired (Yes in Step S54) as a result of the determination made in Step S54, the flow proceeds to Step S59.

In a case where a locator calling signal including the above-described ID has been received, in Step S55, control section 38 sets up TDMA synchronization with mobile information terminal 2 (handset) that is a transmission source of the locator calling signal through radio communication section 37.

In Step S56, control section 38 transmits a locator response signal from radio communication section 37 by instructing radio communication section 37 to transmit the locator response signal that is a response to the locator calling signal. In addition, timer section 44 starts a timer that is used for defining a time limit for communication with mobile information terminal 2.

Again, returning to the operation of mobile information terminal 2, after the locator calling signal is transmitted, mobile information terminal 2 operates as follows.

In Step S44, mobile information terminal 2 performs the process of receiving a response from locator 3 until the timer of timer section 23 expires.

In Step S45, DECT communication control section 28 of mobile information terminal 2 determines whether or not radio communication section 27 has received the locator response signal from locator 3. In a case where radio communication section 27 has not received the locator response signal (No in Step S45) as a result of the determination made in Step S45, the flow proceeds to Step S46. On the other hand, in a case where radio communication section 27 has received the locator response signal (Yes in Step S45) as a result of the determination made in Step S45, the flow proceeds to Step S47.

In Step S46, DECT communication control section 28 determines whether or not the timer of timer section 23 has expired. In a case where the timer of timer section 23 has not expired (No in Step S46) as a result of the determination made in Step S46, the flow is returned to Step S43. On the other hand, in a case where the timer of timer section 23 has expired (Yes in Step S46) without receiving the locator response signal as a result of the determination made in Step S46, the flow proceeds to Step S49.

In Step S47, according to the locator protocol described above, mobile information terminal 2 serves as a synchronization master and communicates with locator 3. In other words, mobile information terminal 2 transmits a request for switching to the information terminal monitoring mode to locator 3. In addition, mobile information terminal 2 performs the process used for receiving a switch completion notification that is transmitted from locator 3 in accordance with the switch request. In Step S48, in a case where the switch completion notification has been transmitted from locator 3, the flow proceeds to Step S49.

In Step S49, the power of DECT communication unit 73 is blocked, and the first timer that counts a time until next DECT communication is performed is started.

Again, returning to the operation of locator 3, after the locator response signal is transmitted in Step S56, locator 3 operates as follows.

In Step S57, locator 3 communicates with mobile information terminal 2 in synchronization with mobile information terminal 2 according to the locator protocol. In other words, when the request for switching to the information terminal monitoring mode is received, locator 3 starts a necessary operation according to the switch request and transmits a switch completion notification to mobile information terminal 2.

In Step S58, DECT communication control section 28 determines whether or not the timer of timer section 44 has expired. In a case where the timer of timer section 44 has not expired (No in Step S58) as a result of the determination made in Step S58, the flow is returned to Step S56. On the other hand, in a case where the timer of timer section 44 has expired (Yes in Step S58) as a result of the determination made in Step S58, the flow proceeds to Step S59.

In Step S59, control section 38 blocks the power supplied to communication block 35. As a result, the communication operation of locator 3 is stopped. In locator 3, the first timer is started in timer section 33, which counts low-speed clock signals supplied from first clock generating section 32, by being triggered upon the blocking of the power supplied to communication block 35. Thereafter, the first timer counts up while the communication operation of locator 3 is stopped.

In Step S60, control section 38 determines whether or not the first timer has expired. As a result of the determination made in Step S60, the standby state is maintained until the first timer expires. In a case where the first timer has expired (Yes in Step S60) as a result of the determination made in Step S60, control section 38 inputs power to communication block 35 again in Step S61.

In Step S61, when power is input to communication block 35, control section 38 instructs radio communication section 37 to start a reception operation. After Step S61, the information terminal monitoring mode operates. In addition, the second timer is started by timer section 44 that counts high-speed clock signals supplied from second clock generating section 43.

Again, returning to the operation of mobile information terminal 2, mobile information terminal 2 operates as follows in the information terminal monitoring mode.

After the power of DECT communication unit 73 is blocked in Step S49, a time is counted by the first timer, and, in a case where the first timer has expired (Yes in Step S70) as a result of the determination made in Step S70, DECT communication control section 28 starts communication again.

In Step S71, DECT communication control section 28 instructs radio communication section 27 to transmit a locator calling signal that is used for calling locator 3.

In Step S72, a reception operation for receiving the locator response signal that is transmitted from locator 3 is started. In addition, mobile information terminal 2 starts timer section 23 and performs an operation of transmitting a locator calling signal and an operation of receiving a response signal from locator 3 until the timer expires.

In Step S73, DECT communication control section 28 of mobile information terminal 2 determines whether or not radio communication section 27 has received the locator response signal from locator 3. In a case where the locator response signal has been received (Yes in Step S73) as a result of the determination made in Step S73, the flow proceeds to Step S74. On the other hand, in a case where the locator response signal has not been received (No in Step S73) as a result of the determination made in Step S73, the flow proceeds to Step S76.

In Step S74, according to the locator protocol described above, mobile information terminal 2 serves as a synchronization master and communicates with locator 3. Mobile information terminal 2 transmits self-location data to locator 3 and receives a locator response signal that is transmitted from the locator 3 in response thereto.

In Step S75, DECT communication control section 28 of mobile information terminal 2 records the self-location data and the information of the “normal” flag in self-location data table 30a.

In Step S76, DECT communication control section 28 determines whether or not the timer of timer section 23 has expired. In a case where the timer of timer section 23 has not expired (No in Step S76) as a result of the determination made in Step S76, the flow is returned to Step S71. On the other hand, in a case where the timer of timer section 23 has expired (Yes in Step S76) without receiving the locator response signal as a result of the determination made in Step S76, the flow proceeds to Step S77.

In Step S77, DECT communication control section 28 records the self-location data in self-location data table 30a and records the information of the “abnormality” flag in self-location data table 30a. Then, the flow is returned to Step S49, and the process waits for next DECT communication.

Again, returning to the operation of locator 3, locator 3 operates as follows in the information terminal monitoring mode.

After the power of the DECT communication block is blocked in Step S59, the time is counted by the first timer, and, in a case where the first timer has expired (Yes in Step S60) as a result of the determination made in Step S60, control section 38 inputs power to communication block 35 again (Step S61).

Then, in Step S61, when power is input to communication block 35, control section 38 instructs radio communication section 37 to start a reception operation for receiving a locator calling signal that is transmitted from mobile information terminal 2. In addition, control section 38 starts the timer section and thereafter performs the operation of receiving the locator calling signal or the operation of communicating with mobile information terminal 2 until the timer expires.

In Step S62, when the locator calling signal transmitted from mobile information terminal 2 is received (Yes in Step S62), control section 38 of locator 3 records the self-location data and the information of the “normal” flag in self-location data table 40a in Step S63.

In Step S64, according to the locator protocol described above, control section 38 of locator 3 communicates with mobile information terminal 2 with mobile information terminal 2 (handset) serving as a synchronization master.

In Step S65, control section 38 transmits a locator response signal to mobile information terminal 2 and records the self-location data transmitted from mobile information terminal 2 in self-location data table 40a.

In a case where the second timer has expired (Yes in Step S66) without a locator calling signal, which has been transmitted from mobile information terminal 2, being received (No in Step S62) by control section 38 of locator 3, the flow proceeds to Step S67. In Step S67, control section 38 of locator 3 records information of the “abnormality” flag in self-location data table 40a. Then, the flow is returned to Step S59 and waits for next DECT communication.

As above, DECT communication unit 73 of mobile information terminal 2 regularly transmits locator calling signals at a predetermined time period (for example, every one minute) using the first timer. Mobile information terminal 2 transmits a locator calling signal using a channel that is receivable for locator 3 and stands by for a response signal transmitted from locator 3. In a case where a response signal in response to a locator calling signal cannot be received in a normal way, the flag representing “abnormality” is attached to self-location data to be recorded in self-location data table 30a. In addition, in a case where a locator calling signal is not transmitted from mobile information terminal 2 regularly, locator 3 attaches a flag representing “abnormality” to self-location data to be recorded in self-location data table 40a.

In addition, in a case where the signal reception level of the response signal does not arrive at a threshold (updated based on learning), DECT communication unit 73 of mobile information terminal 2 may repeat the transmission of a locator calling signal with the period at which a locator calling signal is transmitted (for example, every 10 seconds) being advanced. In addition, in such a case, a flag representing “abnormality” is attached to the self-location data to be recorded in self-location data table 30a.

In addition, in a step in which the signal reception level of the response signal has not arrived at the threshold (updated based on learning), there is a high possibility that locator 3 will be in the missing state, and a weak confirmation sound is generated from notification section 42. Accordingly, in a case where the confirmation sound can be heard by the user, the situation can be immediately improved. When mobile information terminal 2 approaches the user, the user performs an operation such as a resetting operation.

In this way, when a state in which the signal reception level is a predetermined threshold or less is detected, the period at which a terminal calling signal is transmitted is advanced. Accordingly, the possibility of being lost is quickly perceived, and the user can be warned. In addition, when a detection result of the signal reception level of an intermittent calling signal based on the DECT that is received from the locator is lower than the latest threshold set based on the learning, a notification is issued, or a notification to the outside is made, and accordingly, an unnecessary notification can be prevented in advance.

In a case where the state in which a response signal in response to a calling signal is not transmitted in a normal way is continued for a predetermined time (for example, for 30 seconds), locator 3 is recognized to be in a missing state, and a strong warning sound is generated from notification section 42. When the user cannot hear this confirmation sound, or when a predetermined time elapses without being reset described above, the lost state is recognized.

### Example 3

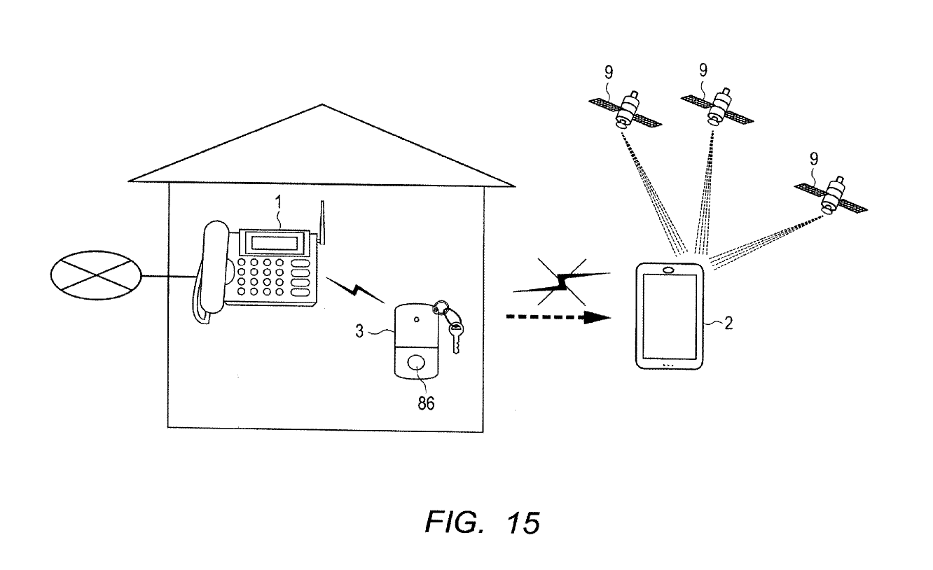

FIG. 15 illustrates an example of a case where a user goes out with mobile information terminal 2 being held with him without possessing locator 3. When a confirmation sound is set to be generated from mobile information terminal 2 in a case where a state is formed in which mobile information terminal 2 and locator 3 cannot communicate with each other regularly, the user can perceive that locator 3 is not with him based on the warning. Accordingly, the user is prevented from mistakenly going out without having locator 3 with him.

On the other hand, in a case where a confirmation sound is set to be generated from locator 3 in a case where a state is formed in which communication cannot be performed in a normal way, the user can perceive that mobile information terminal 2 is not with him based on the warning, and accordingly, the number of cases where the user goes out without having the mobile information terminal with him can be decreased.

In addition, in a case where the user frequently goes out with locator 3 being held with him without having mobile information terminal 2, there is a request for not issuing a notification in a case where locator 3 cannot find mobile information terminal 2. In the state in which mobile information terminal 2 is left in the house, there are many cases where mobile information terminal 2 can communicate with base unit 1. Accordingly, in a case where mobile information terminal 2 and locator 3 cannot communicate with each other in the state in which mobile information terminal 2 and base unit 1 are communicable with each other, the notification mode may be set not to operate.

Furthermore, similar to the previous example, in a case where mobile information terminal 2 is recognized to be in the missing state of being far apart from locator 3 in accordance with the setting, mobile information terminal 2 may generate an outgoing call to a predetermined counterpart destination through public radio network 8. The predetermined counterpart destination, for example, may be base unit 1 of the house connected to the fixed telephone network. In addition, during the communication with the counterpart destination, mobile information terminal 2 may transmit location detection information that is detected by GPS location information calculating unit 72. Also in such a case, similar to the previous example, in the self-location data recorded in self-location data table 30a, data of a “normal” flag and data of an “abnormality” flag are arranged in parallel in a time series, and mobile information terminal 2 may transmit the location detection information to base unit 1. The user can efficiently search locator 3 based on such location information, and a countermeasure for loss and theft thereof can be made promptly.

For example, in a case where mobile information terminal 2 is recognized to be in the missing state, a message for the notification of a state of emergency is transmitted to base unit 1 of the house through public radio network 8. When the emergency checking message is transmitted from mobile information terminal 2, base unit 1 transmits a message for the notification of the state of emergency to all the registered handsets.

### Example 4

Hereinafter, a shift to a locked state in a case where mobile information terminal 2 is recognized to be in the missing state will be described. When a predetermined time elapses without mobile information terminal 2 being reset as described above, mobile information terminal 2 is shifted to the locked state together with performing the above-described notification operation. In accordance with the shift to the locked state, the operation of mobile information terminal 2 is limited. More specifically, an access through a public line and an access to an internal file cannot be made. When the user inputs the password, the mobile information terminal 2 is released from the locked state. From this, in a case where the user becomes far apart from mobile information terminal 2 with locator 3 being held with him, mobile information terminal 2 shifts to the locked state, and unauthorized use of the others can be prevented.

### Example 5

Next, a mode (hereinafter, referred to as a “terminal search mode”) in which a user having locator 3 with him searches for mobile information terminal 2 will be described. After an approximate location of mobile information terminal 2 is specified based on the self-location data, when mobile information terminal 2 is to be searched using locator 3, this “terminal search mode” is used.

As the user presses the input key switch 86 of locator 3, power is input to communication block 35 of locator 3, and communication block 35 performs an operation of searching for mobile information terminal 2. Upon reception of a message indicating that the switch has been pressed (hereinafter, referred to as “switch pressing message”) from locator 3, mobile information terminal 2 transmits a response message that represents the reception of the message to locator 3. The communication performed between locator 3 and mobile information terminal 2 is the same as the operations of Step S71 and subsequent steps thereof and Step S61 and subsequent steps thereof illustrated in FIG. 14.

Within a predetermined time after input key switch 86 is pressed, until a response message can be received from mobile information terminal 2, locator 3 repeatedly transmits the switch pressing message and ends the transmission when the response message can be received.

When the switch pressing message is received from locator 3, mobile information terminal 2 transmits a response message representing the reception of the message to locator 3 and generates a confirmation sound using a voice in accordance with this switch pressing message. When mobile information terminal 2 is located near the user, the user can hear this confirmation sound. The presence of mobile information terminal 2 can be recognized.

In a case where the confirmation sound cannot be heard by the user even when input key switch 86 is pressed, the user performs a search operation.

For example, as the user presses input key switch 86 for a long time of five seconds or more, locator 3 proceeds to the “terminal search mode”. In the “terminal search mode”, first, a terminal calling signal having a signal intensity higher than that of a normal case is transmitted in a channel that is receivable for mobile information terminal 2.

When the terminal calling signal transmitted by locator 3 in the “terminal search mode” is received by mobile information terminal 2, mobile information terminal 2 is switched also to the “terminal search mode”, and, in this “terminal search mode”, mobile information terminal 2 transmits a response message having a signal intensity higher than that of a normal case. When the response message transmitted from mobile information terminal 2 can be received by locator 3, locator 3 is switched to the communication mode synchronized with mobile information terminal 2.

When the user can hear the confirmation sound of mobile information terminal 2 and can immediately recognize the location of mobile information terminal 2, the process ends.

In a case where a time elapses after mobile information terminal 2 starts to transmit the response message to locator 3 and in a case where the reception intensity of the terminal calling signal transmitted from locator 3 is sufficiently strong, mobile information terminal 2 puts a command used for lowering the signal intensity into the response message, and locator 3 lowers the signal intensity by one level in accordance therewith. In addition, in a case where the reception intensity of the terminal calling signal is sufficiently strong still, mobile information terminal 2 puts a command used for lowering the signal intensity into the response message into the response message, and locator 3 lowers the signal intensity further by one level in accordance therewith.

Accordingly, the power consumption of locator 3 is reduced, and a communicable distance between mobile information terminal 2 and locator 3 is sequentially decreased, whereby mobile information terminal 2 can be easily found.

Mobile information terminal 2 changes the pattern of the confirmation sound in accordance with the signal strength of the terminal calling signal that is transmitted from locator 3 and is received by mobile information terminal 2, thereby notifying the user of the degree of approach between mobile information terminal 2 and locator 3.

### Example 6

Next, an operation mode (hereinafter, referred to as an “emergency notification mode”) of a case where locator 3 is used as an emergency button will be described. In this mode, for example, when an abnormality in the user's health occurs, the user transmits a message used for the notification of a state of emergency by performing the following operations by operating input key switch 86 of locator 3.

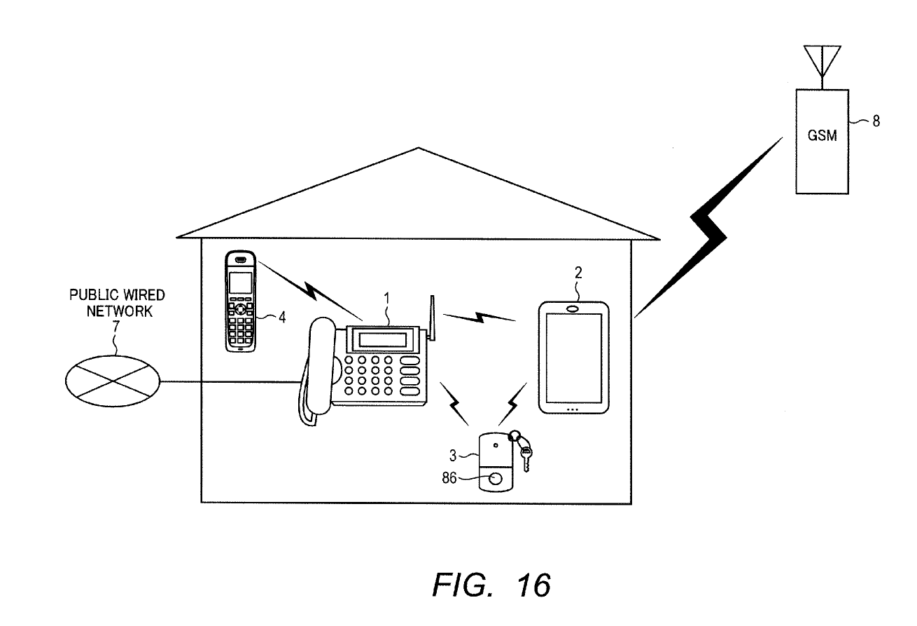

FIG. 16 illustrates an example of a case where the user stays at home while having locator 3 with him, and mobile information terminal 2 is present also in the house. Normally, locator 3 is in the power saving standby state.

As the user presses input key switch 86, power is input to communication block 35 of locator 3, and communication block 35 performs an operation of searching for base unit 1 and an operation of searching for mobile information terminal 2 in parallel with each other.

For example, when a control signal that is transmitted by base unit 1 is received, locator 3 performs a process of taking synchronization with base unit 1. When the synchronization is taken, locator 3 transmits a switch pressing message that represents the pressing of input key switch 86 to base unit 1. In addition, when locator 3 becomes communicable with mobile information terminal 2, locator 3 transmits a switch pressing message that represents the pressing of input key switch 86 to mobile information terminal 2 as well.

When the switch pressing message is received from locator 3, base unit 1 and mobile information terminal 2 transmit response messages representing the reception of the message to locator 3. Until the response message can be received from base unit 1 or mobile information terminal 2 within a predetermined time after the pressing of input key switch 86, locator 3 repeatedly transmits the switch pressing message and ends the transmission when the response message can be received.

Base unit 1 generates a display and a notification sound that represents “a state of emergency” in accordance with the switch pressing message. In addition, base unit 1 can generate a display and a notification sound that represent “a state of emergency” in mobile information terminal 2 and another cordless handset 4 by transmitting the switch pressing message to both mobile information terminal 2 and another cordless handset 4.

In the case of an operation error, the user ends the notification operation by performing a reset operation for base unit 1, mobile information terminal 2, or another cordless handset 4.

In a case where a reset operation is not performed by the user within a predetermined time after the transmission of the switch pressing message, base unit 1 originates a call toward a predetermined emergency notification destination (a request for an ambulance or a notification for the police or any other contact point that is set).

### Example 7

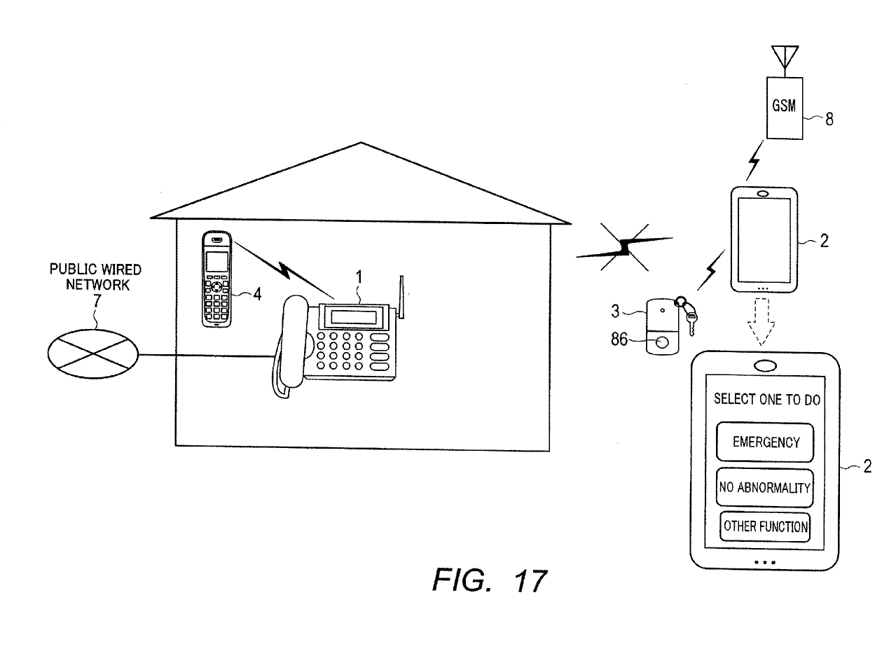

Next, an example of a case will be described in which locator 3 and mobile information terminal 2 are communicable with each other, and both locator 3 and mobile information terminal 2 are not communicable with base unit 1. FIG. 17 illustrates an example of a case where a user goes out with having locator 3 and mobile information terminal 2 with him.

As the user presses input key switch 86, power is input to communication block 35 of locator 3, and locator 3 transmits a switch pressing message that represents the pressing of input key switch 86 to mobile information terminal 2.

When the switch pressing message is received from locator 3, mobile information terminal 2 generates a voice signal and, as illustrated in FIG. 17, displays characters and button icons used for allowing the user to input his intension on operation display section 11. In other words, mobile information terminal 2 displays button icons of “emergency”, “operation error”, and “the other functions” on operation display section 11, thereby inquiring the user whether the input key switch 86 is pressed for an actual emergency, an operation error, or any other purpose.

The user presses the button of “emergency” in the case of an actual emergency. When the button of “emergency” is pressed, mobile information terminal 2 performs an operation for originating a call toward a predetermined emergency notification destination (a request for an ambulance or a notification for the police or any other contact point that is set) through public radio network 8.

In addition, also in a case where a user input operation is not performed within a predetermined time after the display of the above-described button icons, mobile information terminal 2 automatically originates a call toward the emergency notification destination.

### Example 8

Next, an example of a case will be described in which locator 3 and mobile information terminal 2 are communicable with each other, and mobile information terminal 2 and base unit 1 are not communicable with each other through the DECT.

In this case, the operations of mobile information terminal 2 until the operation for originating a call toward the emergency notification destination is performed after the switch pressing message is received from locator 3 are the same as those described above. In addition, mobile information terminal 2 also transmits an emergency checking message to base unit 1.

While the switch pressing message is transmitted from locator 3 and the operation for originating a call toward the emergency notification destination is performed, mobile information terminal 2 can also notify base unit 1 of a state of emergency through public radio network 8.

When the emergency checking message transmitted from mobile information terminal 2 through public radio network 8 is received, base unit 1 transmits a message used for notifying all the registered handsets of the emergency.

### Example 9

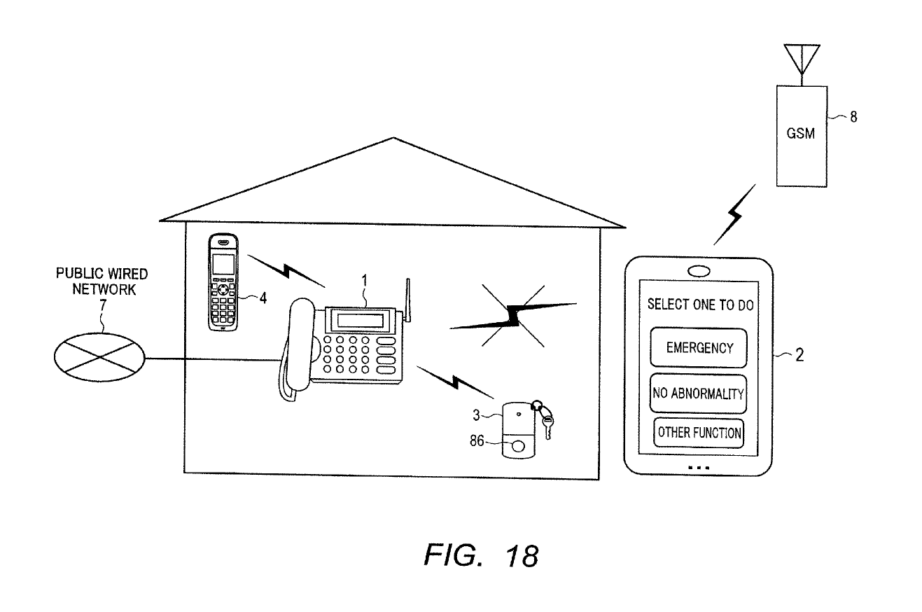

Next, an example of a case will be described in which only locator 3 and base unit 1 are communicable with each other, locator 3 and mobile information terminal 2 are not communicable with each other, and mobile information terminal 2 and base unit 1 are not communicable with each other through the DECT. FIG. 18 illustrates an example in which the user has locator 3 with him in the house, and mobile information terminal 2 cannot perform communication through DECT.

The switch pressing message of locator 3 is not transmitted to mobile information terminal 2. The switch pressing message is transmitted only to base unit 1. In accordance with this switch pressing message, while base unit 1 tries to make a DECT communication link with registered mobile information terminal 2 and transmit a notification message to mobile information terminal 2, there is no response from mobile information terminal 2. In this step, base unit 1 cannot determine whether the pressing of the button is due to an actual state of emergency or an operation error.

In accordance with the switch pressing message of locator 3, in the case of a mode in which base unit 1 needs to immediately make a notification to the outside, in a case where the user does not perform a resetting operation within a first predetermined time (up to 20 seconds) after the transmission of the switch pressing message, base unit 1 performs an operation of originating a call toward a predetermined emergency notification destination (a request for an ambulance or a notification for the police or any other contact point that is set).

In the case of an operation error, the user performs a resetting operation for base unit 1 or cordless handset 4, whereby the state is returned to the normal state.

At the time of reception of the switch pressing message of locator 3, in a case where base unit 1 is in a terminal linked mode in which the operation is determined after an emergency checking message transmitted from mobile information terminal 2 is checked, base unit 1 operates in the following sequence.

When the switch pressing message is transmitted, base unit 1 transmits an inquiry call to mobile information terminal 2 through public radio network 8, and the state thereof is changed to a warning state within a second predetermined time (up to 120 seconds) after the transmission of the switch pressing message.

As a user using mobile information terminal 2 that has received a call through public radio network 8 presses the button of “normal,” and whereby an emergency checking message in which information of “abnormality” is carried is returned from mobile information terminal 2 to base unit 1.

During the warning state, base unit 1 abstains from other communications through a public line. During the warning state, when the emergency checking message is transmitted from mobile information terminal 2 to base unit 1 and represents information of “normal,” the warning state is reset. In addition, the resetting operation may be performed in a different manner.

In this warning state, in a case where an emergency checking message is transmitted from mobile information terminal 2, and information of “a state of emergency” can be carried therein or a case where a message or the like that is used for the notification of a state of emergency is not transmitted even when a second predetermined time elapses after the switch pressing message, base unit 1 originates a call toward a predetermined emergency notification destination (a request for an ambulance or a notification for the police or any other contact point that is set).

### Example 10

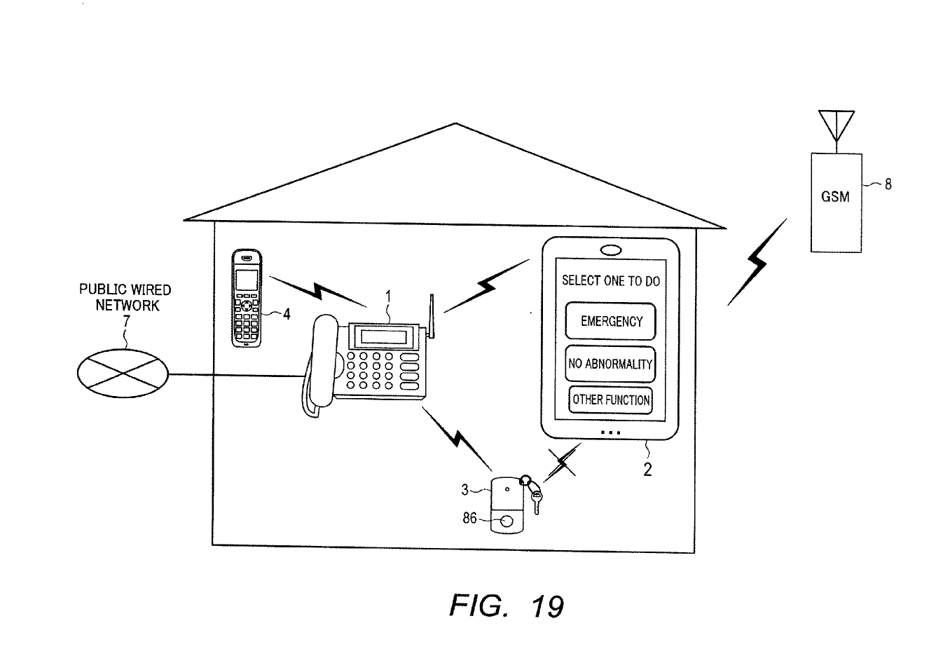

Next, an example of a case will be described in which locator 3 and base unit 1 are communicable with each other, base unit 1 and mobile information terminal 2 are communicable with each other, and locator 3 and mobile information terminal 2 are not communicable with each other. FIG. 19 illustrates an example of this state.

In this case, even when the user presses input key switch 86, the switch pressing message is not transmitted to mobile information terminal 2. The switch pressing message is transmitted only to base unit 1.

When the switch pressing message is received from locator 3, base unit 1 makes a DECT communication link with registered mobile information terminal 2 and transmits a notification message representing that there is the switch pressing message to mobile information terminal 2. Mobile information terminal 2 generates a confirmation sound using a voice in accordance with this notification message. When the user has mobile information terminal 2 with him, the user can hear this confirmation sound.

In addition, similar to the above-described example and the case illustrated in FIG. 17, mobile information terminal 2 displays button icons used for inquiring the user whether input key switch 86 is pressed due to an actual emergency, an operation error, or any other purpose.

In the case of an actual emergence, the user presses the button of “emergency”. in a case where the button of “emergency” is pressed, mobile information terminal 2 transmits an emergency checking message to base unit 1 and, depending on the settings, mobile information terminal 2 performs an operation of originating a call toward a predetermined emergency notification destination (a request for an ambulance or a notification for the police or any other contact point that is set).

In addition, in a case where a user input operation is not performed within a predetermined time after the display of the button icons, mobile information terminal 2 spontaneously performs the operation of originating a call toward the emergency notification destination.

In addition, when the emergency checking message is transmitted, base unit 1 transmits a message for the notification of the state of emergency to all the registered handsets.

Hereinafter, examples in which various functions are provided in the locator will be described.

### Example 11

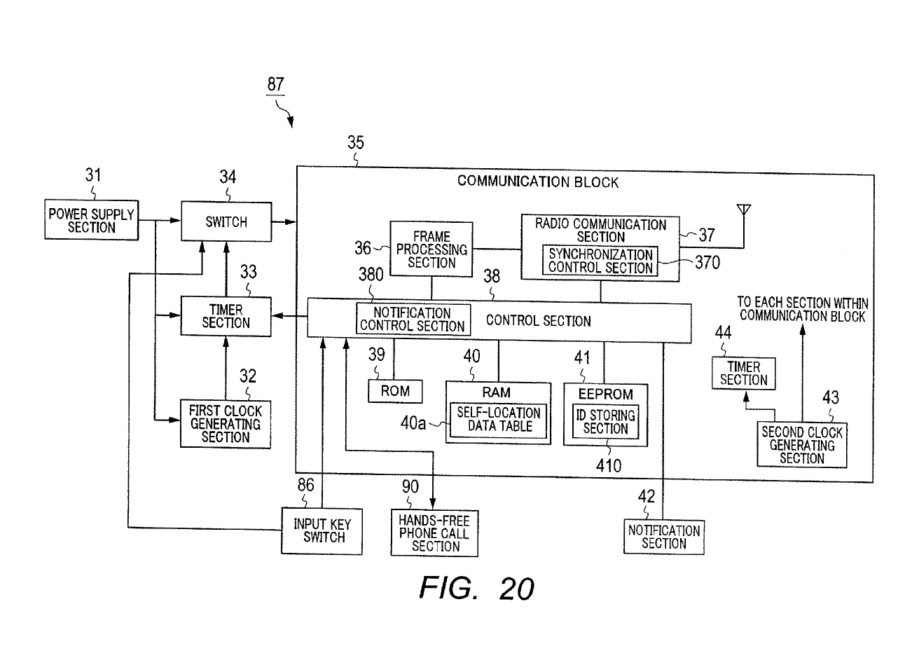

FIG. 20 illustrates the configuration of locator 87 in which hands-free phone call section 90 is arranged. The hands-free phone call section 90 includes a microphone, a speaker, a voice amplifier section used for a hands-free phone call, and the like.

More specifically, in a case where a distance between mobile information terminal 2 and locator 87 is far apart, and the reception level of a signal received by mobile information terminal 2 from locator 87 decreases to be a specific threshold or less, there is a high possibility that locator 87 will be in a missing state, and a weak confirmation sound is generated from notification section 42. As a result, both parties make a phone call by starting phone call functions, whereby the state can be checked. In addition, the user operates hands-free phone call section 90 by operating to start a phone call using input key switch 86 and sets a voice phone call channel between locator 87 and mobile information terminal 2, and accordingly, a state is formed in which a voice phone call can be made.

For example, in Step S8 represented in FIG. 7, according to the locator protocol, mobile information terminal 2 transmits a locator calling signal to locator 87 and transmits a command for setting a voice channel with being carried in this locator calling signal. In addition, in Step S27, locator 87 performs a control process in accordance with the command for setting a voice channel that is carried in the locator calling signal, whereby a voice channel is set between mobile information terminal 2 and locator 87.

Alternatively, regardless of the communication state between mobile information terminal 2 and locator 87, it may be configured such that a calling signal is transmitted from mobile information terminal 2 to locator 87 based on the operation of mobile information terminal 2, a command for generating a confirmation sound is added in the calling signal, and a command for operating hands-free phone call section 90 is further added therein. Accordingly, hands-free phone call section 90 of locator 87 is forcibly operated by the operation of starting a phone call in mobile information terminal 2, and a state can be formed in which a phone call can be immediately made. In a case where children possess locator 87, this function is effective.

In this way, a hands-free voice call can be made in locator 87, and, for example, by allowing different persons to respectively have mobile information terminal 2 and locator 87 at outdoor locations, a simplified phone call can be made in a range in which DECT communication can be performed in a case where the two persons separately act. For example, there are advantages in which both parties can be in contact with each other in a shopping store or the like, or a missing child can be searched while a person talks with him.

Alternatively, by attaching a locator capable of making a hands-free phone call to a pet such as a dog, a person can talk with the pet from a remote place, and accordingly, the pet can be called based on the talk or the state of the pet can be known.

### Example 12

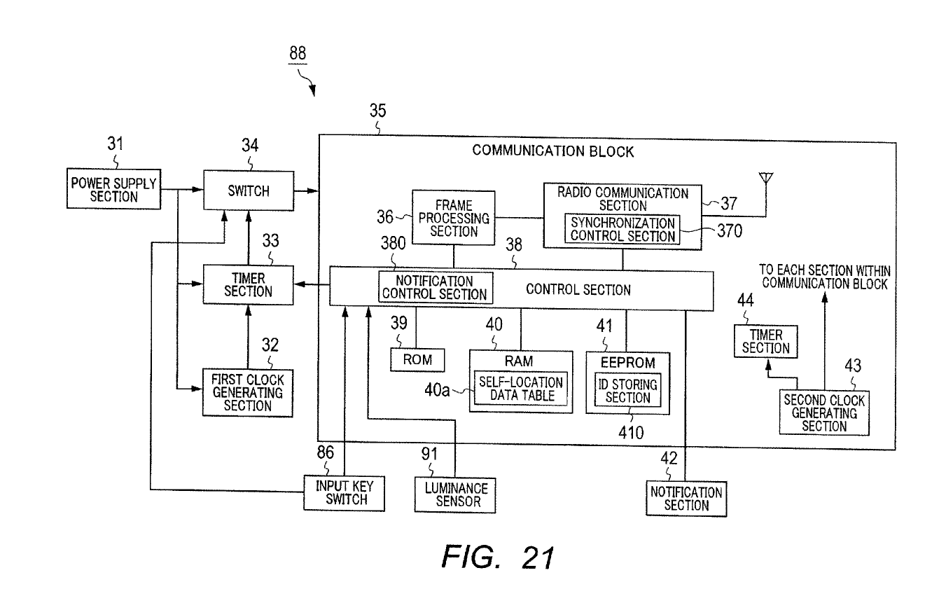

FIG. 21 illustrates the configuration of locator 88 in which luminance sensor 91 is arranged. Luminance sensor 91 outputs “ON” in a case where the luminance is higher than a predetermined level, luminance sensor 91 outputs “Off” in a case where the luminance is lower than a predetermined level, and the output of this luminance sensor 91 is transmitted to control section 38.

For example, in Step S8 represented in FIG. 7, according to the locator protocol, mobile information terminal 2 transmits a locator calling signal to locator 88, and, in Step S27, locator 88 transmits a locator response signal to mobile information terminal 2. At that time, locator 88 carries the output information of luminance sensor 91 in the locator response signal and transmits the locator response signal to mobile information terminal 2.

Mobile information terminal 2 displays information representing whether locator 88 is located at a bright place or a dark place at that time on operation display section 11 based on the output information of this luminance sensor 91. In this way, the user using mobile information terminal 2 can acquire the information representing whether the place at which the locator 88 is located is a bright place or a dark place at the time of searching for locator 88, and accordingly, it becomes easy to find locator 88.

### Example 13

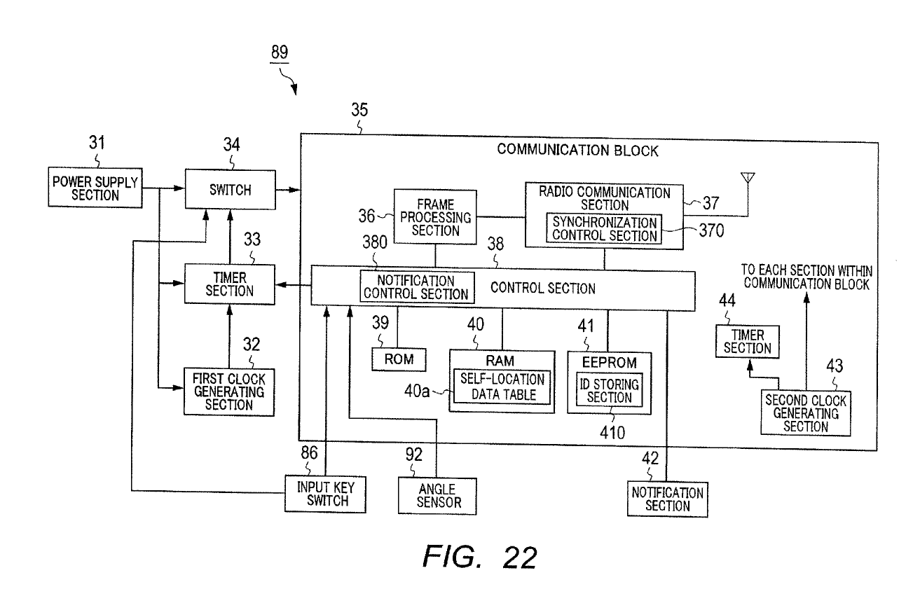

FIG. 22 illustrates the configuration of locator 89 in which angle sensor 92 is arranged. Angle sensor 92 detects a change in the direction in which locator 89 is placed and outputs information that represents whether locator 89 is stopped or the posture thereof is changed. The output information of this angle sensor 92 is transmitted to control section 38.

For example, in Step S27 represented in FIG. 7, when locator 89 transmits a locator response signal to mobile information terminal 2, locator 89 transmits the output information of angle sensor 92 to mobile information terminal 2 with being carried in the locator response signal.

Mobile information terminal 2 displays information that represents whether the locator 89 at that time is in a stopped state or in a moving state on operation display section 11 based on the output information of this angle sensor 92. In this way, the user using mobile information terminal 2 can acquire information that represents whether locator 89 is in the stopped state or, for example, is held by another person (or placed in a vehicle), and it becomes easy to find locator 89.

### INDUSTRIAL APPLICABILITY

A locator system, a mobile information terminal, and a locator according to the present invention are useful for a system and an apparatus performing a search for items using near field radio communication. With the locator system, mobile information terminal, and locator according to the present invention, a link between a locator and a highly functional mobile information terminal is built. Accordingly, when one of the locator and the terminal cannot be found, the user can promptly recognize that one of the devices has been missing and can effectively look for the device. In addition, a notification can be appropriately given at the time of emergency.

### REFERENCE SIGNS LIST

1 Base unit
2 Mobile information terminal
3, 5, 87, 88, 89 Locator
7 Public wired network
8 Public radio network
10 Main control section
11 Operation display section
63 Line control section
14 Notification section
24 Phone call section
25 Input key switch
28 DECT communication control section
30 RAM
30a Self-location data table
27, 37, 67 Radio communication section
38, 68 Control section
34 Switch
35 Communication block
40 RAM
40a Self-location data table
41, 51, 82 EEPROM
42 Notification section
86 Input key switch
71 Public radio communication unit
72 GPS location information calculating unit
73 DECT communication unit
77 Calculation control section

1. A locator system comprising:
a mobile information terminal that includes a public radio communication section performing radio communication with a public radio network and that includes a near field radio communication section performing communication with a specific apparatus using a near field radio communication protocol; and
a radio communication section that communicates with the mobile information terminal using a near field radio communication protocol, wherein:
the mobile information terminal transmits a locator calling signal used for calling a locator regularly and waits for a response signal when the mobile information terminal is set in a locator monitoring mode, the response signal being transmitted from the locator; and
the mobile information terminal generates a confirmation sound when a state in which the mobile information terminal does not receive the response signal in a normal way continues for a predetermined time, the response signal being transmitted from the locator in response to the locator calling signal.

2. The locator system according to claim 1, wherein:
the near field radio communication protocol is a communication protocol compliant with a time division multiple access (TDMA)/time division duplex (TDD) standard in which one frame is divided into N slots; and
when transmitting the locator calling signal, the mobile information terminal, first, performs consecutive transmission of a calling signal, waits for the response signal to be transmitted from the locator regularly during the consecutive transmission, stops the consecutive transmission of the calling signal by being triggered upon reception of the response signal and transmits a calling signal corresponding to one slot at a predetermined period and receives a response signal corresponding to one slot at a timing shifted from a timing of the transmission of the calling signal after the consecutive transmission stops.

3. The locator system according to claim 1, wherein, when detecting that a reception level of the signal transmitted from the locator is lower than a predetermined threshold level, the mobile information terminal operates while regarding that a normal response is not transmitted from the locator.

4. The locator system according to claim 1, wherein:
the mobile information terminal includes a GPS location information calculating section that detects a location using a global positioning system;
the mobile information terminal originates a call toward a predetermined counterpart destination registered in advance through the public radio network when a normal response is not transmitted from the locator for an operation of calling the locator of the mobile information terminal and when a predetermined operation is not performed even after a predetermined time elapses after start of the calling operation; and
the mobile information terminal transmits data including at least self-location data at a time when it is found that a normal response is not transmitted from the locator and self-location data at a time when a normal response is transmitted from the locator most recently, the self-location data being recorded in the mobile information terminal.

5. The locator system according to claim 1, wherein the period of the operation of calling the locator is controlled to be shortened in accordance with an instruction transmitted from outside of the locator system through the public radio network.

6. The locator system according to claim 1, wherein:
the mobile information terminal includes an input key switch; and
when a normal response is not transmitted from the locator for an operation of calling the locator, the mobile information terminal permits an emergency notification using the input key switch.

7. The locator system according to claim 6, wherein the emergency notification causes a predetermined call origination operation to be performed through the public radio network.

8. The locator system according to claim 1, wherein the mobile information terminal further includes a reset operation section that allows a user to reset the mobile information terminal through an operation of the mobile information terminal.

9. A locator system comprising:
a mobile information terminal that includes a public radio communication section performing radio communication with a public radio network and that includes a near field radio communication section performing communication with a specific apparatus using a near field radio communication protocol; and
a locator that includes a radio communication section performing communication with the mobile information terminal using a near field radio communication protocol and that includes a user operable switch, wherein:
the radio communication section of the locator performs an operation of searching for the mobile information terminal in accordance with a user operation of pressing the switch; and
upon reception of a switch pressing message from the locator, the mobile information terminal transmits a response message representing the reception of the message and generates a confirmation sound.

10. The locator system according to claim 9, wherein the locator transmits a terminal calling signal having a signal intensity higher than that of a normal case using a channel receivable by the mobile information terminal when a terminal search mode starts in accordance with the user operation.

11. The locator system according to claim 9, wherein:
the locator includes a section that issues a warning when a periodic calling is not received from the mobile information terminal;
the mobile information terminal shifts to a locked state in which an operation of the mobile information terminal is restricted, when a normal response is not transmitted from the locator in response to an operation of calling the locator; and
the mobile information terminal is released from the locked state when a password is inputted to the mobile information terminal.

12. The locator system according to claim 9, wherein the locator is switched to a communication mode synchronized with the mobile information terminal upon reception of the response message from the mobile information terminal.

13. The locator system according to claim 9, wherein:
the mobile information terminal puts a command used for lowering the signal intensity into the response message if the reception intensity of the terminal calling signal transmitted from the locator is sufficiently high when a time elapses after start of transmission of the response message from the mobile information terminal to the locator; and
the locator lowers the signal intensity by one level in accordance with the command.

14. The locator system according to claim 13, wherein:
the mobile information terminal puts the command used for lowering the signal intensity into the response message if the reception intensity of the terminal calling signal is sufficiently high; and
the locator lowers the signal intensity further by one level in accordance with the command.

15. The locator system according to claim 9, wherein the mobile information terminal changes a pattern of a confirmation sound in accordance with the signal intensity of the terminal calling signal transmitted from the locator.

16. A locator system comprising:
a mobile information terminal that includes a public radio communication section performing radio communication with a public radio network, that includes a near field radio communication section performing communication with a specific apparatus using a near field radio communication protocol and that includes an operation display section used for receiving various operations and performing various display operations; and
a locator that includes a radio communication section communicating with the mobile information terminal using a near field radio communication protocol and that includes a key switch operable by a user, wherein:
the locator performs an operation of searching for the mobile information terminal by starting the radio communication section by operating the key switch, and upon reception of a response from the mobile information terminal, the locator transmits a switch pressing message to the mobile information terminal;
the mobile information terminal sounds a voice signal and performs a display operation on the operation display section for allowing a user intention to be inputted, upon reception of the switch pressing message from the locator; and
the mobile information terminal automatically performs an operation of originating a call toward an emergency notification destination when a predetermined operation is performed by the user or when no user input operation is performed within a predetermined time after the display operation is performed.

17. The locator system according to claim 16, wherein the mobile information terminal displays at least a button icon that represents a state of emergency or an operation error on the operation display section upon reception of the switch pressing message from the locator.

18. A mobile information terminal comprising:
a public radio communication section that performs radio communication with a public radio network;
a near field radio communication section that performs communication with a specific apparatus using a near field radio communication protocol;
an operation display section that is used for receiving various operations and performing various display operations;
a notification section that generates a sound; and
a control section, wherein
when the mobile information terminal is set in a locator monitoring mode, the control section controls the near field radio communication section to transmit a locator calling signal used for calling the locator regularly and waits for a response signal transmitted from the locator, and the control section controls the notification section to generate a confirmation sound when a state in which a response signal transmitted from the locator in response to the locator calling signal is not received in a normal way continues for a predetermined time.

19. The mobile information terminal according to claim 18, wherein:
the near field radio communication protocol is a communication protocol compliant with a time division multiple access (TDMA)/time division duplex (TDD) standard in which one frame is divided into N slots; and
an operation of transmitting the calling signal using (N−1) slots and then waiting for reception of the response signal using one slot is performed regularly.

20. A locator comprising:
a radio communication section that performs communication with a mobile information terminal using a near field radio communication protocol; and
a notification section that generates a confirmation sound, wherein
upon reception of a calling signal transmitted from the mobile information terminal, the radio communication section transmits a response signal to the mobile information terminal in response to the calling signal.

21. A locator comprising:
a radio communication section that performs communication with a mobile information terminal using a near field radio communication protocol;
a notification section that generates a confirmation sound; and
a key switch that is operable by a user, wherein:
the radio communication section performs an operation of searching for the mobile information terminal by operating the key switch; and
upon reception of a response from the mobile information terminal, the locator transmits a switch pressing message to the mobile information terminal.
